(19) United States
(12) Patent Application Publication
(10) Pub. No.: US 2026/0082202 A1
(43) Pub. Date: Mar. 19, 2026

(54) RANDOM MEDIA ACCESS CONTROL (MAC) ADDRESS FOR ROAMING

(71) Applicant: Cisco Technology, Inc., San Jose, CA (US)

(72) Inventors: Binita GUPTA, San Diego, CA (US); Jerome HENRY, Pittsboro, NC (US); Brian D. HART, Sunnyvale, CA (US)

(21) Appl. No.: 19/281,641

(22) Filed: Jul. 26, 2025

Related U.S. Application Data
(60) Provisional application No. 63/695,803, filed on Sep. 17, 2024.
(60) Provisional application No. 63/825,448, filed on Jun. 17, 2025.

(51) Int. Cl. H04W 8/08; H04W 12/037; H04W 12/0471; H04W 76/15

(52) U.S. Cl. CPC H04W 8/08; H04W 12/037; H04W 12/0471; H04W 76/15

(57) ABSTRACT

The present disclosure provides techniques for client device roaming using randomized media access control (MAC) addresses in enhanced data privacy (EDP) operation. A first access point (AP) in a seamless mobility domain (SMD) receives a message as part of an initial association process with a station (STA). The first AP establishes one or more roaming-specific media access control (MAC) addresses (RMAs) for the STA as part of message exchange during the initial association process. The first AP establishes a first pairwise transient key (PTK) with the STA and generates a PTK mapping that associates the first PTK with the one or more RMAs of the STA.

### CROSS-REFERENCE TO RELATED APPLICATIONS

This application claims benefit of co-pending U.S. provisional patent application Ser. No. 63/695,803 filed Sep. 17, 2024 and U.S. provisional patent application Ser. No. 63/825,448, filed Jun. 17, 2025. The aforementioned related patent application is herein incorporated by reference in its entirety.

### TECHNICAL FIELD

Embodiments presented in this disclosure generally relate to wireless communication. More specifically, embodiments disclosed herein relate to facilitating secure roaming.

### BACKGROUND

Seamless roaming within a Seamless Mobility Domain (SMD) has been introduced in ultra-high reliability (UHR) to improve mobility and facilitate a smooth transition between access points (APs) without requiring a full reauthentication process. A seamless roaming procedure involves a station (STA) transitioning from its currently associated AP to a target AP multi-link device (MLD) during roaming events. This technique is generally applicable to a variety of roaming scenarios, but is particularly beneficial in cases where the STA experiences a sudden drop in received signal strength indicator (RSSI) from its associated AP and has to perform a last-minute roam to the target AP to maintain connectivity. In an SMD, roaming is typically achieved through a shared or pre-established security key, such as a pairwise transient key (PTK), allowing the target AP to quickly authenticate and decrypt the roaming request from the STA.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example SMD where a STA roams from a first AP (AP 1) to a second AP (AP 2), and the STA's MAC address changes every epoch, according to some embodiments of the present disclosure.

FIG. 2A depicts an example SMD where a roam-specific MAC address is included in a roaming request and a PTK mapping is shared between APs to facilitate a STA's roaming, according to some embodiments of the present disclosure.

FIG. 2B depicts an example SMD where a roam-specific MAC address is included in a roaming request, and both an address mapping and a PTK mapping are shared between APs to facilitate a STA's roaming, according to some embodiments of the present disclosure.

FIG. 3A depicts an example SMD where a roam-specific MAC address is included in a roaming request and a per-AP PTK is established during an initial association and reused to protect the roaming request, according to some embodiments of the present disclosure.

FIG. 3B depicts an example SMD where a roam-specific MAC address is included in a roaming request and a per-AP PTK is established during an initial association and reused to protect the roaming request, according to some embodiments of the present disclosure.

FIG. 4 depicts an example sequence of interactions between a STA and two APs, where the STA roams from one AP to another using a shared PTK, according to some embodiments of the present disclosure.

FIG. 5 depicts an example sequence of interactions between a STA and two APs, where the STA roams between the two APs using different PTKs, according to some embodiments of the present disclosure.

FIG. 6 depicts an example method for a first AP (AP 1) handling an initial association and sharing PTK mappings with other APs in the same SMD, according to some embodiments of the present disclosure.

FIG. 7 depicts an example method for a second AP (AP 2) receiving a roaming request and decrypting the roaming request using a shared PTK, according to some embodiments of the present disclosure.

FIG. 8 depicts an example method for a STA performing an initial association with a first AP (AP 1) and roaming to a second AP (AP 2), where the roaming request is protected using a PTK generated and shared by the first AP, according to some embodiments of the present disclosure.

FIG. 9 depicts an example method for a first AP (AP 1) handling an initial association and generating per-AP PTK mappings, according to some embodiments of the present disclosure.

FIG. 10 depicts an example method for a first AP (AP 1) receiving a roaming request and decrypting the roaming request using a previously established per-AP PTK, according to some embodiments of the present disclosure.

FIG. 11A depicts an example method for a STA performing initial association with a first AP (AP 1), generating a per-AP PTK mapping, and storing the per-AP PTK mapping for future reassociation, according to some embodiments of the present disclosure.

FIG. 11B depicts an example method for a STA roaming back to a first AP (AP 1), where the roaming request is protected using a previously generated per-AP PTK for the first AP (AP 1), according to some embodiments of the present disclosure.

FIG. 12 is a flow diagram depicting an example method performed by an AP for shared PTK mapping generation, according to some embodiments of the present disclosure.

FIG. 13 is a flow diagram depicting an example method performed by a STA for per-AP PTK mapping generation, according to some embodiments of the present disclosure.

FIG. 14 depicts an example network device configured to perform various aspects of the present disclosure, according to some aspects of the present disclosure.

FIG. 15 depicts an example client device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a first access point (AP) in a seamless mobility domain (SMD), a message as part of an initial association process with a station (STA), establishing, by the first AP, one or more roaming-specific media access control (MAC) addresses (RMAs) for the STA as part of message exchange during the initial association process, establishing, by the first AP, a first pairwise transient key (PTK) with the STA, and generating, by the first AP, a PTK mapping that associates the first PTK with the one or more RMAs of the STA.

One embodiment presented in this disclosure provides a method, including sending, by a station (STA) in a seamless mobility domain (SMD), a message as part of an initial association process to a first access point (AP), establishing, by the STA, one or more roaming-specific media access control (MAC) addresses (RMAs) with the first AP as part of message exchange during the initial association process, establishing, by the STA, a first pairwise transient key (PTK) with the first AP, where the first PTK is used specifically for protecting communication between the first AP and the STA and cannot be used for protecting communications with any other second APs in the SMD; and generating, by the STA, a per-AP PTK mapping, where the per-AP PTK mapping associates the first AP with the first PTK, and one or more second APs in the SMD with respective PTKs, each established through a separate association process and used for communication between the STA and respective second APs.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### Example Embodiments

In the context of Wi-Fi and other wireless communication systems, a Seamless Mobility Domain (SMD) refers to a network architecture designed to enable seamless roaming for devices (e.g., smartphones, laptops, and Internet-of-Things (IoT) devices) across multiple APs or networks without interruption. The goal of an SMD is to provide a unified and consistent user experience as a device moves between different Access Points (APs) or network segments. In recent standards for UHR, seamless roaming within an SMD has been proposed to address scenarios where a STA experiences a sudden drop in RSSI from its associated AP and must perform a last-minute roam to a new AP to maintain connectivity.

Typically, a PTK is shared across APs within the SMD. When a STA roams to a target AP, the roaming request sent to the target AP is protected using protected management frames (PMF) encrypted with the shared PTK. The target AP uses the shared PTK of the STA to decrypt the protected request and execute the roaming process. However, to enable this mechanism, the target AP needs to identify the non-AP multi-link device (MLD) (also referred to as the STA) based on the Transmitter Address (TA) in the roaming request and fetch the corresponding PTK to decrypt and process the message.

A challenge arises with the introduction of EDP mode in IEEE 802.11bi, which enforces MAC address randomization at predefined epoch boundaries. When a STA roams to a new AP, its MAC address (included within the TA field) changes, making it difficult for the target AP MLD to recognize the STA and retrieve the corresponding PTK for decrypting the roaming request. Without a mechanism to correctly map the STA's identity to its security credentials, roaming may fail, leading to increased latency, reauthentication overhead, or even disconnection.

To address these challenges and other relevant concerns, embodiments of the present disclosure provide systems, methods, and apparatuses that enable secure and efficient roaming within an SMD, even when MAC randomization (e.g., EDP mode) is enabled. The disclosed embodiments introduce the use of a roaming-specific MAC address, which is different from the primary MAC address used during regular association and data transmission and is changed at defined epoch boundaries in accordance with EDP requirements. The roaming-specific MAC address is used exclusively for roaming events and serves as a reference point for identifying the previously established PTK associated with the roaming STA. By using this approach, the target AP can correctly recognize and authenticate the STA and enable faster and more efficient transitions between APs, even when the STA's primary MAC address is changed periodically (e.g., under the EDP mode).

As used herein, the roaming-specific MAC address refers to a randomized MAC address used by non-AP MLD/STA when performing over-the-air roaming with a target AP MLD/AP. This address may also be referred to as identifiable random MAC (IRM) in associated state (IRM-A), randomized MAC address for roaming (RMR), or roaming MAC address (RMA). The RMA serves as a static identifier for the STA during roaming, even when its primary MAC address changes per epoch under EPD mode.

In one embodiment, a shared PTK is used across all APs within the SMD for a given STA. The shared PTK is mapped to the RMA address, such as provided by the STA, during the initial association process. The mapping is then shared with all APs in the SMD, so that any target AP can retrieve the correct PTK for decrypting the roaming request. In embodiments where a distribution system (DS) MAC address is included within the association request, the mapping may be generated between the Transmitter Address (TA) (e.g., RAM address) and the DS MAC address, and the DS MAC address may then be mapped to the PTK. Such layered mapping allows the target AP to correctly identify the STA and retrieve the appropriate PTK, even when the STA's roaming-specific MAC address changes. As used herein, the DS MAC address refers to a MAC address used for communication within a distribution system (DS). The DS MAC address is associated with a STA and typically remains consistent across sessions or epochs, even when other MAC addresses (e.g., IRM) change for privacy purposes. The DS MAC address may serve as a stable reference for identifying the STA and facilitating key management, such as retrieving a previously established PTK during roaming.

In one embodiment, different PTKs are established for each AP-STA pair. In this configuration, the RMA address is included within the roaming request to help the target AP identify the correct PTK for the STA. The PTK for the target AP is directly mapped to the RMA address. In embodiments where a DS MAC address is used, the RMA may be mapped to the DS MAC address, and the PTK for the target AP may also be mapped to the DS MAC address. This allows the target AP to resolve the STA's identity and retrieve the correct PTK for decryption.

In some embodiments, the roaming request may include one or more next RMAs for future roaming. In this configuration, the STA preemptively provides the new randomized MAC addresses for use in a subsequent roaming event. The target AP may store the next address and use it to update its mappings. In some embodiments, the next RMAs may instead be assigned by the AP, and the STA stores the assigned address locally for use during its next roaming event.

To avoid conflicts with existing MAC addresses, in one embodiment, the AP may perform a collision check on the provided RMA. If a conflict is detected, the AP may send a message indicating an address conflict (e.g., using a status code such as “ADDRESS_CONFLICT”). In response to the conflict, the AP may either assign one or more RMAs to the STA or request the STA to provide one or more new RMAs for further verification.

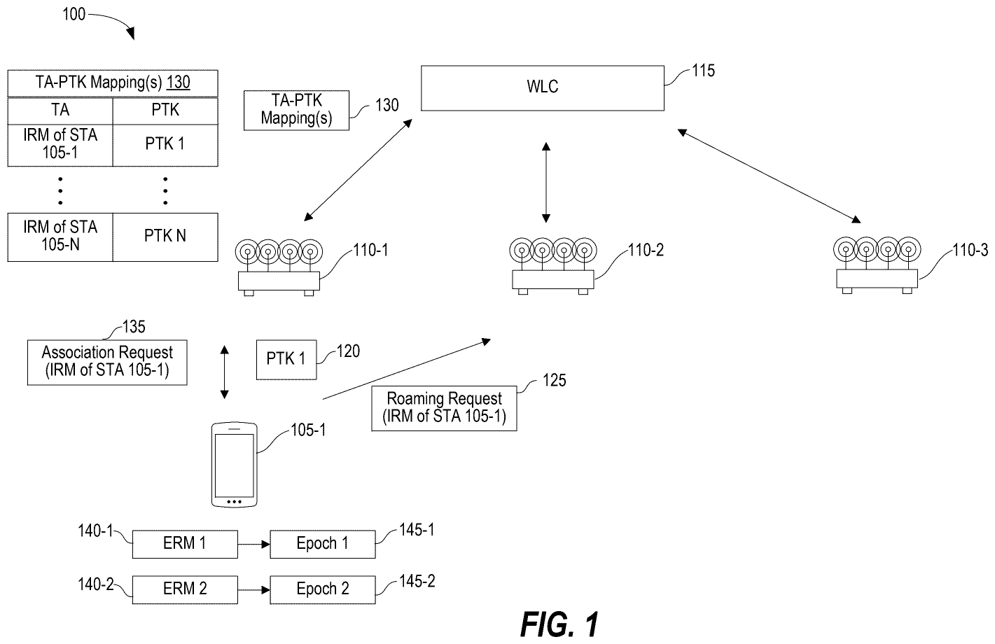

FIG. 1 depicts an example SMD 100 where a STA 105-1 roams from a first AP (AP 1) 105-1 to a second AP (AP 2) 105-2, and the STA's MAC address 140 changes every epoch, according to some embodiments of the present disclosure.

As depicted, the example SMD 100 includes three APs: AP 110-1, AP 110-2, and AP 110-3. All three APs are controlled by a wireless local area network (LAN) controller (WLC) 115. A STA 105-1 is initially associated with AP 110-1 and intends to roam to AP 110-2. As used herein, the AP may refer to either a single-link AP or a multi-link AP (AP MLD). A single-link AP operates on a single wireless link (e.g., a single frequency band or channel), and an AP MLD supports multiple links concurrently. As used herein, the STA may refer to either a single-link STA or a multi-link STA (STA MLD). The STA may be a smartphone, laptop, Internet-of-Things (IoT) device, and the like.

As depicted, a PTK 1 (120) is established between STA 105-1 and AP 110-1 (also referred to as AP 1 hereafter) during the association process. Following the 802.11bh standard, the Identifiable Random Media Access Control (IRM) address of STA 105-1 is provided in the association process exchange indicated by 135 during the 4-way handshake. Upon establishment of PTK 1 (120), AP 110-1 generates a mapping 130 between PTK 1 (120) and the IRM address of STA 105-1. The IRM address is later used by the STA as TA (transmitter address) in frames sent to the AP (e.g. probe request frame) if it prefers to be recognized by the network. Hence, this mapping 130 is referred to as TA-PTK Mapping. This mapping 130 may be shared with the WLC 115. In some embodiments, the WLC may distribute the shared mapping 130 to the other APs in the SMD, including AP 110-2 (also referred to as AP 2 hereafter) and AP 110-3 (also referred to as AP 3 hereafter). In some embodiments, the WLC 115 may cache the TA-to-PTK mapping in a centralized database. When a target AP (e.g., AP 110-2 or AP 110-3) in the same SMD receives a roaming request from STA 105-1, it may query the WLC with the IRM to retrieve the corresponding PTK for completing the roaming process.

In embodiments where AP 110-1 connects to N STAs, a total of N TA-PTK mappings 130 may be generated and shared with the WLC 115. Within each mapping, the IRM address of a respective STA is associated with its corresponding PTK.

As depicted, when STA 105-1 decides to roam to AP 110-2, it sends a roaming request 125 to AP 110-2. The roaming request 125 includes the IRM address of STA 105-1 in the Transmitter Address (TA) field and is protected using PTK 1. Upon receiving the roaming request 125, the AP 110-2 retrieves the PTK 1 from the shared TA-PTK mapping 130 (e.g., provided by the WLC). The AP 110-2 then uses the PTK 1 to verify the integrity check (MIC) attached to the roaming request or decrypt the encrypted roaming request. In some embodiments, the roaming request may be sent as a Reassociation Request frame, Link Reconfiguration Request frame, Add Link/Delete Link Request frame, or any other frame used to perform over-the-air roaming through the target AP MLD. If the MIC is valid (e.g., the computed MIC matches the attached MIC), this confirms that the message has not been tampered with or compromised (e.g., by a man-in-the-middle (MiTM) attack) and was sent from a legitimate STA that possesses the correct PTK. AP 110-2 then authenticates STA 105-1 and sends a roaming response (e.g., a Reassociation Response frame or a Link Reconfiguration Response), allowing STA 105-1 to complete the roaming process.

As depicted, in EDP mode defined in 11bi, the STA address of STA 105-1 may change at defined epoch boundaries. Essentially STA uses new randomized MAC addresses for each epoch, and the STA's MAC address used in the EDP mode changes at each EDP epoch boundary for use in the next epoch. As used herein, the STA's IRM address that changes at each epoch under EDP may also be referred to as the EDP random MAC address (ERM). As used herein, an epoch refers to a window or a duration of time having a fixed and predefined length. The predefined length may range from a few seconds to a few hours, during which operational parameters such as the STA's randomized MAC address remain valid before being refreshed. For example, ERM 1 (140-1) is used during epoch 1 (145-1), and ERM 2 (140-2) is used during epoch 2 (145-2). Such randomization is designed to improve user privacy by preventing long-term tracking of the STA's 105-1 identity. In this configuration, when STA 105-1 sends a roaming request 125 to AP 110-2, the ERM address included in the TA field (of the MAC header of the roaming request) may no longer match the address stored in the shared PTK mapping(s) (e.g., the MAC address provided in the initial association). As a result, AP 110-2 cannot recognize STA 105-1 based on the TA field and therefore cannot retrieve the corresponding PTK (e.g., PTK 1).

Without the ability to identify the STA 105-1 and retrieve the correct PTK (e.g., PTK 1), AP 110-2 cannot authenticate STA 105-1 or process the roaming request. As a result, the STA 105-1 needs to initiate a full authentication process (as in normal operation without SMD capabilities). This may involve performing a new 4-way handshake to establish a PTK with AP 110-2, which introduces significant latency and authentication overhead. Such delays are particularly problematic in scenarios that require UHR and low-latency communication (e.g., real-time video streaming).

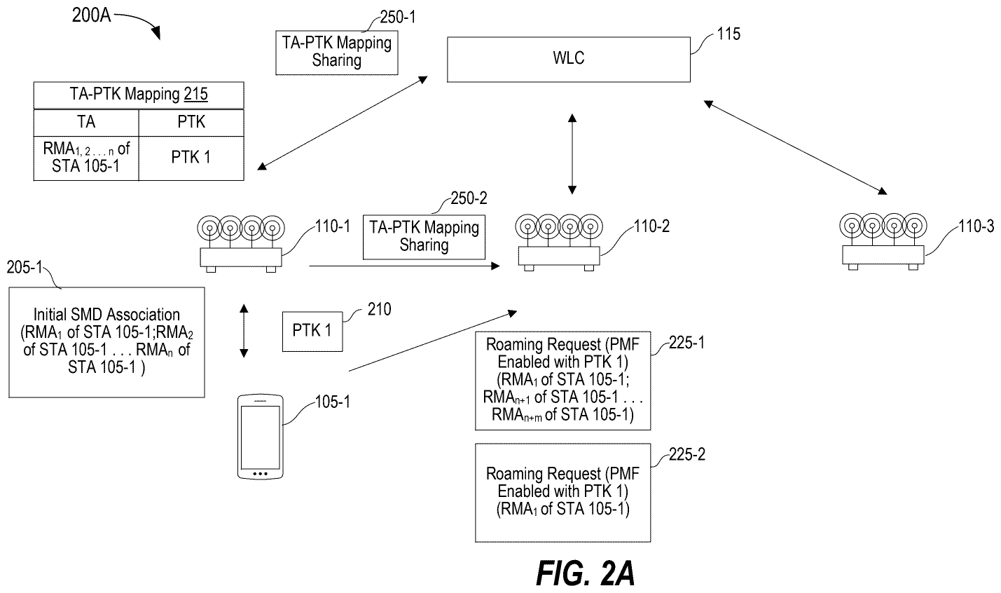

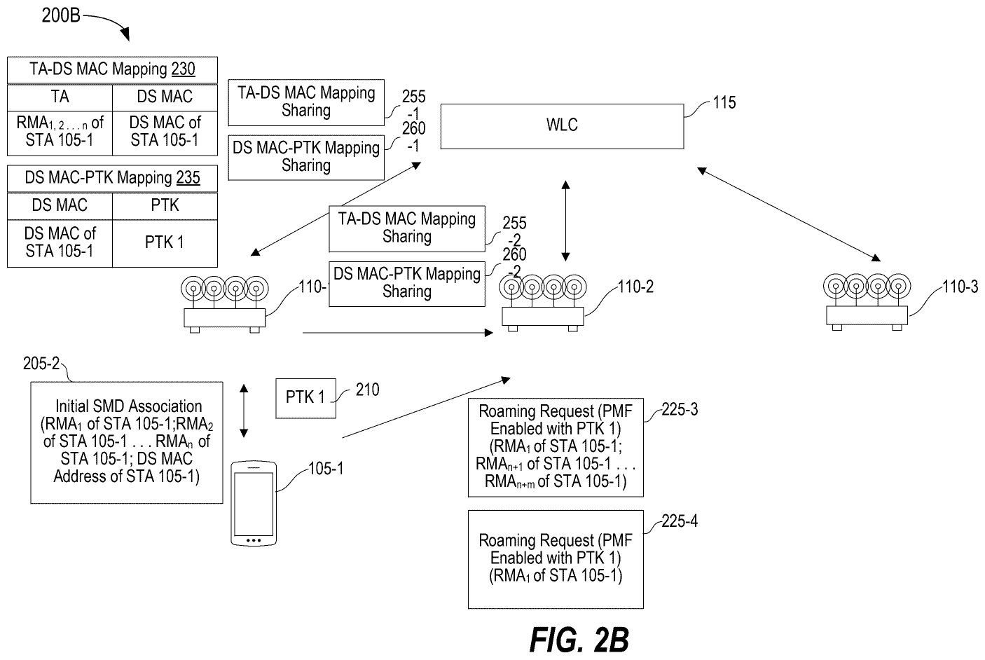

To address the ERM address issue described above, embodiments of the present disclosure provide a method that enables seamless roaming within an SMD, even when the ERM address 140 of the STA 105-1 changes per epoch 145 under EDP mode. This can be achieved through the generation and use of one or more roaming-specific MAC addresses (RMAs). The RMA serves as a static identifier for the STA 105-1 during roaming, regardless of changes to its primary STA address 140, which can change at every EDP epoch. In one embodiment, the one or more RMAs may be valid for use in the follow-up roaming event and then get updated as part of that roaming event. Further details about the generation and use of the RMA, as well as the overall roaming process, are discussed below with references to FIGS. 2A and 2B.

FIG. 2A depicts an example SMD 200A where a roam-specific MAC address is included in a roaming request 225 and a PTK mapping 215 is shared between APs of the SMD to facilitate a STA's roaming within the SMD, according to some embodiments of the present disclosure.

As depicted, the example SMD 200A includes three APs: AP 110-1, AP 110-2, and AP 110-3. In one embodiment, all three APs are connected and controlled by a WLC 115. In one embodiment, a STA 105-1 generates one or more roaming-specific MAC addresses (RMAs). The RMA address may also be referred to as the IRM-A or RMR. In another embodiment, the one or more RMAs are assigned by the AP 110-1 to the STA 105-1 during the association or the 4-way handshake process.

As illustrated, STA 105-1 initially associates with AP 110-1. During this process, one or more RMAs (e.g., RMA₁ to RMAₙ) are provided for future roaming use. The RMAs are transmitted as part of the initial SMD association 205-1. In some embodiments, these RMAs are generated by STA 105-1 and conveyed as part of the (re)association request or 4-way handshake, for example, within EAPOL M2 or M4. The one or more RMAs set up during the initial association process are intended to be used in the next roaming event, allowing a target AP in the same SMD to recognize STA 105-1 and retrieve the shared PTK 1 when the STA 105-1 later roams away from AP 110-1. In some embodiments, the RMAs may be included within a (re)association request (e.g., (Re)Association Request frames or Link Reconfiguration Request frames).

In other embodiments, the RMAs may be assigned by the AP 110-1 and transmitted to the STA 105-1 as part of the 4-way handshake process, such as within EAPOL M1 or M3. In some embodiments, the RMAs may be included within a (re)association response (e.g., (Re)Association Response frames or Link Reconfiguration Response frames).

In embodiments that comply with IEEE 802.11bi Enhanced Data Privacy (EDP), the Association Request frame and/or 4-way handshake messages may be encrypted. Accordingly, any RMA transmitted during association exchange or in the 4-way handshake is protected from eavesdropping. Specifically, the RMA may be conveyed within a Key Data Element (KDE), similar to the IRM KDE or Device ID KDE as defined in IEEE 802.11bh. A new Key Data element (RMA KDE) can be defined to carry the RMA.

As depicted, the RMAs (e.g., RMA₁ to RMAₙ) are used as randomized STA identifiers for roaming. These addresses enable APs to correctly recognize STA 105-1 and retrieve the appropriate PTK. More specifically, the association of RMAs with PTK 1 forms the TA-PTK mapping 215. In one embodiment, the mapping 215 is shared with the WLC 115, as depicted by message flow 250-1. The WLC 115 may then distribute the mapping to the other APs in the same SMD (e.g., AP 110-2 or AP 110-3) or store it in a centralized database for future query-based retrieval. In some embodiments, the mapping 215 is sent directly to other APs 110 using over-the-DS exchanges between the APs or using action frames or other over-the-air (OTA) management frames (protected or unprotected), as depicted by message flow 250-2.

When STA 105-1 decides to roam to AP 110-2, STA 105-1 sends a roaming request 225 to AP 110-2. As used herein, the roaming request 225 may include a Reassociation Request frame, a Link Reconfiguration frame, an Add Link/Delete Link Request frame, or any other frame used to perform OTA roaming through the target AP MLD. The roaming request 225 is PMF-protected using PTK 1 and includes a current RMA of STA 105-1 (e.g., one of RMA₁ to RMAₙ) in the TA field (within the MAC header of the roaming request). Upon receiving the roaming request 225, AP 110-2 extracts the RMA (e.g., RMA₁) from the TA field of the request 225. Using the shared TA-PTK mapping 215 provided by the WLC 115 or received directly from another AP, AP 110-2 identifies STA 105-1 and retrieves the corresponding PTK 1.

In some embodiments, when the STA is configured for generating RMAs, the roaming request 225-1 may additionally include one or more future RMAs (e.g., RMAₙ₊₁ to RMAₙ₊ₘ) that are intended to be used for subsequent roaming events. These may be conveyed within KDEs or new elements/subelement/fields in the roaming request to support providing RMAs for use for next roaming. In other embodiments, where the RMAs are assigned by the APs, the roaming request 225-2 may include only the current RMA (e.g., one of RMA₁ to RMAₙ) in the TA field. In such cases, the AP 110-2 may respond with a roaming response (e.g., a Reassociation Response frame or a Link Reconfiguration frame) (not shown) that includes a set of new RMAs (e.g., RMAₙ₊₁ to RMAₙ₊ₘ) generated by the AP for future use by STA 105-1 for next roaming. The future RMAs may be sent when the current communicated RMAs (e.g., RMA₁ to RMAₙ) are nearing expiration or have been consumed due to previous roaming events.

Using the retrieved PTK 1, AP 110-2 verifies the integrity of the received roaming request 225 (that is encrypted with PTK). More specifically, AP 110-2 computes the MIC over the received frame using PTK 1 and compares it to the MIC included in the frame. If the computed MIC matches the MIC within the frame, this confirms that the message has not been tampered with or compromised (e.g., by a MiTM attack) and was sent from a legitimate STA that possesses the correct PTK. Once verified, AP 110-2 authenticates STA 105-1 and uses the mapped PTK to decrypt the roaming request and proceeds with sending a roaming response (e.g., a Reassociation Response frame or a Link Reconfiguration Response frame) (not shown) that allows STA 105-1 to complete the roaming process.

As depicted, the RMAs (e.g., RMA₁ to RMAₙ) are used as randomized STA identifiers for roaming. With these addresses, APs can correctly recognize STA 105-1 and retrieve the appropriate PTK, even if the primary MAC address of STA 105-1 changes every epoch under EDP mode. The use of RMAs enables STA 105-1 to transition seamlessly from AP 110-1 to AP 110-2 without requiring reauthentication or re-establishment of security credentials (e.g., a new PTK between STA 105-1 and AP 110-2).

In the SMD, each AP 110 may maintain a local cache table or similar data structure to store the shared TA-PTK mappings 215 received from the WLC 115 or directly from peer APs. These mappings associate one or more RMAs with PTK 1. In some embodiments, the cache table may include metadata such as timestamps or validity periods to define when each mapping was last updated or when it expires. In some embodiments, the WLC 115 may maintain a centralized mapping table for all APs in the same SMD. In such configurations, each AP may dynamically query the WLC 115 with a received RMA to retrieve the corresponding PTK or associated roaming context when a roaming request is received.

In some embodiments, each RMA is designed for one-time or short-duration use, such as for a single roaming event. For example, the RMA₁ setup at the time of initial SMD association 205-1 is used when STA 105-1 roams away from AP 110-1 to a target AP (e.g., AP 110-2). Within the roaming request 225 sent to the target AP, the STA 105-1 provides the RMA₁, which the target AP (e.g., AP 110-2) uses as a reference to retrieve PTK 1 from the shared mapping. In a subsequent roaming request, a second RMA, such as RMA₂, may be used. This mechanism improves security and privacy by preventing attackers from tracking the STA's movement over time using the roaming-specific address. For example, if an attacker were to intercept the RMA (e.g., RMA₁), it would only be valid for a limited time or a single roaming event. This reduces the risk of long-term tracking. In some embodiments, the RMA may have a time-based expiration, where the STA 105-1 or the AP provides a new RMA in advance of the expiration to maintain the RMA for use for the next seamless and secure roaming. In one embodiment, for a given roaming event, all the roaming requests sent for a given roaming event (e.g., a roaming preparation request and a roaming execution request) use the same RMA, to preserve RMAs and not require assigning more RMAs (either by the STA or the AP). In another embodiment, for better privacy, a different RMA is used in each roaming request sent as part of a single roaming event. For example, a roaming preparation request sent to the AP may use RMA₁ and a follow-up roaming execution request sent to the AP may use a different RMA, say RMA₂.

As discussed above, to support the dynamic address update, the roaming request 225-1 may include future RMAs when STA-based generation is used. Upon receiving these RMAs (e.g., RMAₙ₊₁ to RMAₙ₊ₘ), AP 110-2 updates the TA-PTK mapping 215 by associating each new RMA with PTK 1 and distributes the updated mappings via WLC 115 or directly to other APs through over-the-DS or, in some cases, using OTA signaling. In cases where the AP is the RMA source, AP 110-2 may deliver a set of new RMAs in the roaming response for the STA 105-1 to cache. In some embodiments, the RMAs may be encoded within the roaming request/response as either a new element (e.g., Next Roaming Address) or as a subelement or field/subfield of an existing element.

FIG. 2B depicts an example SMD 200B where one or more roam-specific MAC addresses (RMAs) are included in a roaming request 225, and both a DS address mapping 230 and a PTK mapping 235 are shared between APs to facilitate a STA's roaming, according to some embodiments of the present disclosure.

Unlike FIG. 2A, where the RMA is directly mapped to the PTK, FIG. 2B introduces an additional layer of mapping by using the DS MAC address as an intermediate identifier. The two-layer mapping approach (RMA to DS MAC and DS MAC to PTK) provides added flexibility and compatibility with systems or architectures that identify STAs using DS MAC addresses.

As depicted, STA 105-1 initially associates with AP 110-1 and, during the association process, provides both a set of RMAs (e.g., RMA₁ to RMAₙ) and a DS MAC address. In some embodiments, these identifiers are exchanged during the 4-way handshake. For example, the STA 105-1 may generate and transmit the RMAs in EAPOL M2 or M4. In other embodiments, the RMAs are assigned by AP 110-1 and delivered to the STA 105-1 in EAPOL M1 or M3. In some embodiments, the RMAs may be included within a (re)association request (e.g., (Re)Association Request frames or Link Reconfiguration Request frames) or when assigned by the AP in a (Re)association response (e.g., (Re)Association Response frames or Link Reconfiguration Response frames).

During this process, AP 110-1 establishes two mappings: an address mapping 230 (also referred to in some embodiments as a TA-DS MAC mapping) that associates RMAs (e.g., RMA₁ to RMAₙ) included within the TA field with the DS MAC address, and a PTK mapping 235 (also referred to in some embodiments as a DS MAC-PTK mapping) that associates the DS MAC address with the PTK 1 generated for STA 105-1.

In configurations conforming to IEEE 802.11bi EDP, 4-way handshake messages such as M3 and M4 may be encrypted (partially encrypted) to protect sensitive STA identifiers. Accordingly, the RMA and DS MAC addresses may be included within the encrypted portion of the EAPOL messages of 4-way handshake. Particularly, the RMA and DS MAC addresses may be encapsulated in a new KDE similar to the KDE used for IRM or Device ID (the IRM KDE or Device ID KDE as specified in IEEE 802.11bh).

Both the address mapping 230 and the PTK mapping 235 may be shared with other APs using one of two approaches. In one embodiment, the mappings are shared with the WLC 115 (as depicted by message flows 255-1 and 260-1), which can then distribute the mappings to peer APs or store them in a centralized database for future query-based retrieval. In another embodiment, the mappings are sent directly from AP 110-1 to other APs over-the-DS or using action or other suitable OTA management frames (as depicted by message flows 255-2 and 260-2).

When STA 105-1 roams to AP 110-1, it sends a roaming request 225 (e.g., a Reassociation Request frame or a Link Reconfiguration Request frame) to AP 110-2. The roaming request 225 includes the current RMA (e.g., RMA₁) in the TA field and is protected using PTK 1. In embodiments where the STA generates the RMAs, the roaming request 225-3 may also include one or more next (e.g., RMAₙ₊₁ to RMAₙ₊ₘ) that are intended for use in subsequent roaming events. These additional RMAs may be included as part of an information element or subelement/field/subfield in the roaming request. In embodiments where the AP is configured to generate the RMAs, the roaming request 225-4 includes only the current RMA (e.g., RMA₁), and the AP 110-2 may return a set of newly assigned RMAs (e.g., RMAₙ₊₁ to RMAₙ₊ₘ) in the roaming response (not shown) to be cached by the STA 105-1 for future use for the next roaming.

Upon receiving the request 225, AP 110-2 first resolves the current RMA (e.g., RMA₁) to the associated DS MAC address using the shared address mapping 230. AP 110-2 then retrieves the corresponding PTK 1 using the shared PTK mapping 235. With PTK 1, AP 110-2 verifies the MIC for the roaming request using the mapped PTK. If the MIC is valid, AP 110-2 can then decrypt the roaming request using the PTK and send a response (e.g., a Reassociation Response frame or a Link Reconfiguration Response frame) to approve the roaming request.

The use of a DS MAC address provides an additional layer of indirection for PTK mapping, where the PTK is mapped to the DS MAC address instead of directly to the roaming-specific MAC address. The two-layer mapping is particularly beneficial when the RMA is updated frequently, such as when it changes every roaming event for enhanced security and privacy. Since the DS MAC address remains static within the SMD, APs can use it as a lookup key to retrieve the correct PTK and avoid disruptions caused by the frequent changes to the RMA.

As discussed above in FIG. 2A, STA 105-1 also includes one or more next RMAs (e.g., RMAₙ₊₁ to RMAₙ₊ₘ) in the roaming request when the STA is configured for RMA generation, or AP may provide next RMAs in the roaming response. In both cases, AP 110-2 may update the address mapping 230 to associate each of the next RMAs with the STA's existing DS MAC address. AP 110-2 may then share the updated address mappings with other APs 110 directly or via the WLC 115. In this configuration, the PTK mapping 235 does not need to be updated, as the DS MAC address remains unchanged. In some embodiments, one or more of the next RMAs may be included or embedded within the encrypted portion of the roaming request/response.

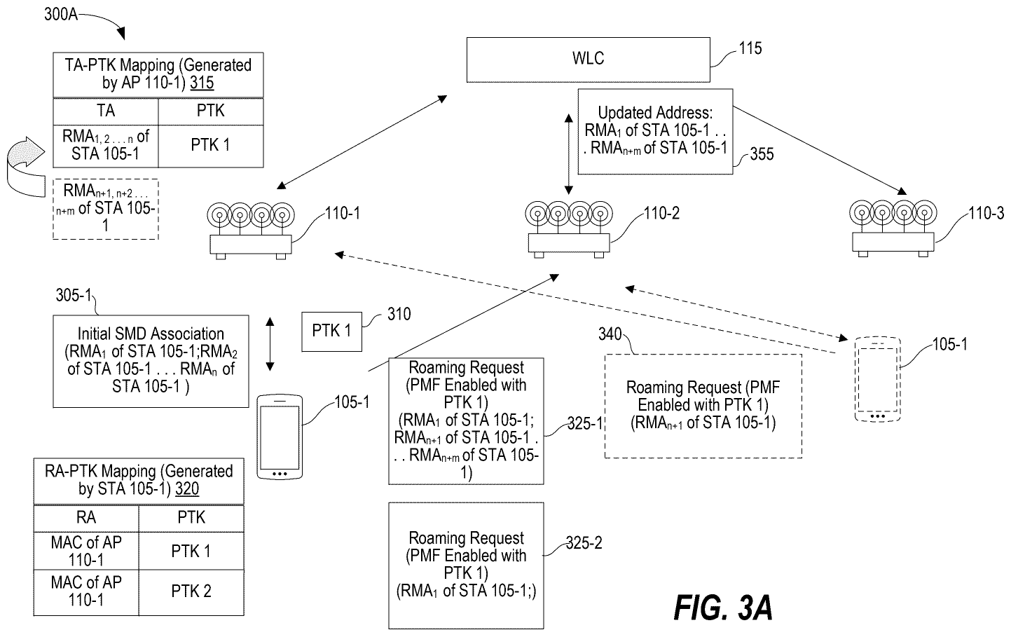

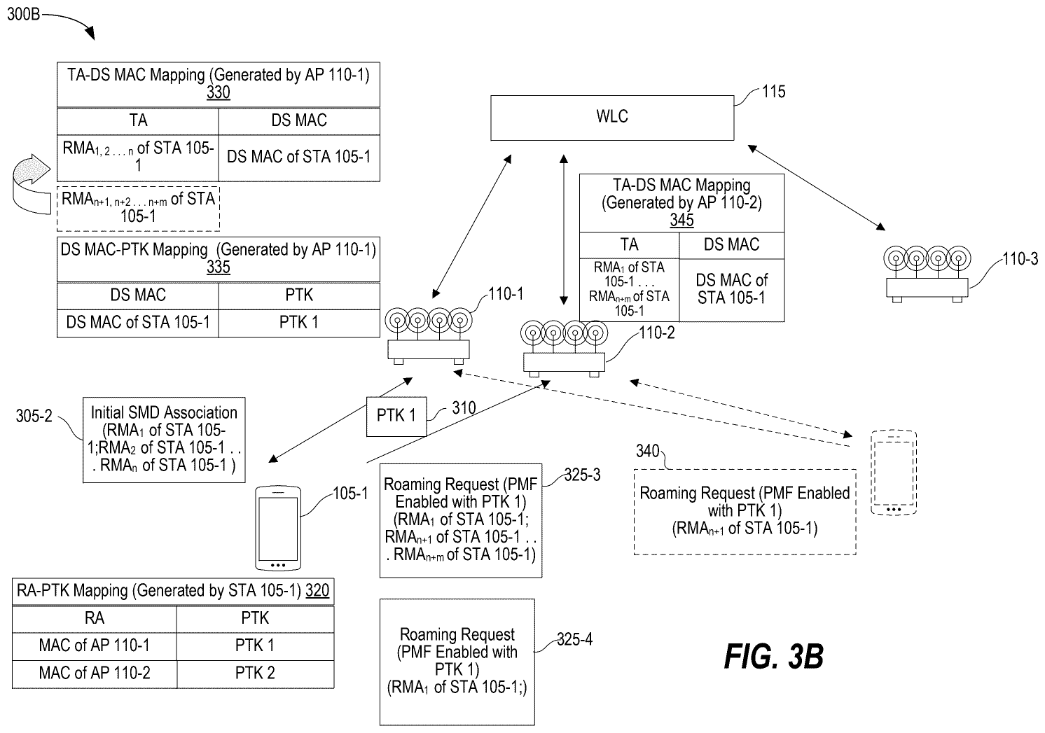

FIG. 3A depicts an example SMD 300A where a roam-specific MAC address is included in a roaming request 325 and a per-AP PTK 310 is established during an initial association and reused to protect the roaming request, according to some embodiments of the present disclosure.

As depicted, the example SMD 300A includes STA 105-1 and three APs: AP 110-1, AP 110-2, and AP 110-3. All three APs are controlled by the WLC 115. As depicted, during the association process 305-1 with AP 110-1, one or more RMAs (e.g., RMA₁ to RMAₙ) are provisioned. In some embodiments, the RMAs are generated by the STA and transmitted in EAPOL M2 or M4. In other embodiments, the RMAs are assigned by the AP and transmitted in EAPOL M1 or M3. In some embodiments, the RMAs may be included within a (re)association request (e.g., (Re)Association Request frames or Link Reconfiguration Request frames).

A per-AP PTK 1 (310) is established between AP 110-1 and STA 105-1. Unlike the shared PTK approach discussed in FIGS. 2A and 2B, the per-AP PTK can only be used by the specific AP and STA pair for which it was generated. For example, PTK 1, established between AP 110-1 and STA 105-1, can only be used by the two devices when the STA 105-1 roams back to AP 110-1.

Following association, AP 110-1 generates a TA-PTK mapping 315 that associates each received RMA (e.g., RMA₁ to RMAₙ) with PTK 1 (310). The mapping 315 is stored locally by AP 110-1 and not shared with other APs in the SMD. Similarly, STA 105-1 generates a RA-PTK mapping 320 that associates the MAC address of AP 110-1 (included within the Receiver Address (RA) field) with PTK 1. This mapping 320 allows the STA 105-1 to identify the correct PTK to use when communicating with AP 110-1.

When STA 105-1 roams to AP 110-2, it sends a roaming request 325 (e.g., a Reassociation Request frame or a Link Reconfiguration Request frame) to AP 110-2. In embodiments where the STA 105-1 determines the RMA, the roaming request 325-1 may include a current RMA (e.g., one of RMA₁ to RMAₙ) and one or more next RMAs (e.g., RMAₙ₊₁ to RMA ₙ₊ₘ). Since the system uses per-AP PTK, and AP 110-1 does not share its TA-PTK mapping with AP 110-2, AP 110-2 and STA 105-1 initiate a new 4-way handshake to establish PTK 2. After the handshake, AP 110-2 generates a TA-PTK mapping (not shown) that associates the received RMAs with PTK 2, and STA 105-2 updates its RA-PTK mapping 320 to associate the MAC address of AP 110-2 with PTK 2. In embodiments where the AP assigns the RMA, the roaming request 325-2 includes only the current RMA (e.g., one of RMA₁ to RMAₙ). When the current communicated RMAs (e.g., RMA₁ to RMAₙ) are nearing expiration or have been consumed due to previous roaming events, the AP 2 assigns the future RMAs and includes them within a roaming response (not shown).

In addition, as depicted, AP 110-2 may also share the updated address information 355 (e.g., RMA₁ to RMAₙ₊ₘ) with other APs in the SMD, either directly or via the WLC 115. This allows AP 110-1 to update its local TA-PTK mapping 315 to recognize STA 105-1 in future roaming events using the new RMAs.

Later, as depicted, if STA 105-1 decides to roam back to AP 110-1 (e.g., due to improved signal strength or movement back into the coverage area of AP 110-1), STA 105-1 sends a roaming request 340 (e.g., a Reassociation Request frame) back to AP 110-1, which is PMF-protected using PTK 1. In preparing the request 340, STA 105-1 checks its RA-PTK mapping 320 and retrieves PTK 1. If the next RMA in the sequence is RMA₂, the STA 105-1 includes RMA₂ in the request 340. If RMA₂ to RMAₙ have been used or expired due to roaming events or timeouts, the STA 105-1 includes RMAₙ₊₁ within the request 340. Upon receiving the request 340, AP 110-1 extracts the current RMA, retrieves PTK 1 from its updated mapping 315, and verifies the MIC. If valid, AP 110-1 authenticates STA 105-1 and sends a roaming response (e.g., a Reassociation Response frame or a Link Reconfiguration Request frame) to establish links and complete the roaming process. In embodiments where the STA generates the RMAs, the STA may additionally include one or more future RAMs (e.g., RAMₙ₊ₘ₊₁ to RMAₙ₊ₘ₊ₚ) in the request 340.

In some embodiments, the one or more next RAMs provided in a roaming request may be used exclusively with the AP that receives the roaming request. For example, RMAₙ₊₁ to RMAₙ₊ₘ included in the request 325 to AP 110-2 may be valid only for AP 110-2 and mapped to PTK 2. If STA 105-1 later roams back to AP 110-2, it may include RMAₙ₊₁ as the next address, which is intended solely for use with AP 110-2 in a subsequent handoff (e.g., when STA 105-1 roams from another AP back to AP 110-2). In such configurations, each AP maintains its own TA-PTK mapping independently and does not need to share updated RMA information with other APs. This configuration still allows the STA 105-1 to be recognized and authenticated correctly by each AP 110 during future roaming, as long as both the STA and the AP maintain a consistent mapping between the RMA and the established PTK. This approach aligns with the isolation principles of the per-AP PTK model, where each AP maintains its own security credentials and mappings independently.

As discussed, in the per-AP PTK scenarios, since PTKs are not shared across APs, STA 105-1 needs to perform a full authentication process (including a 4-way handshake) to establish a new PTK (e.g., PTK 2) with AP 110-2 when it roams from AP 110-1 to AP 110-2. This process introduces additional latency and authentication overhead compared with the shared PTK approach as disclosed in FIGS. 2A and 2B. However, once PTK 2 is established, STA 105-1 can seamlessly roam back to AP 110-2 in the future without requiring reauthentication or re-establishment of security credentials. Similarly, when STA 105-1 roams back to a previously associated AP (e.g., AP 110-1), it can use the existing PTK 1 to protect the roaming request, and AP 110-1 can authenticate the STA without performing a full 4-way handshake. Therefore, although the per-AP PTK approach requires a full authentication process during the initial roaming event to a new AP, it simplifies the roaming process for subsequent roaming events to previously associated APs.

In the SMD 300A, AP 110-1 saves the TA-PTK mapping 315 in a local cache table or similar data structure. In embodiments where AP 110-1 connects to N STAs 105, a total of N mappings may be saved, with each mapping associating the RMA of a respective STA with its corresponding PTK. The cache table allows AP 110-1 to quickly retrieve the correct PTK for a given STA during a roaming event. STA 105-1 saves the RA-PTK mapping 320 in a local cache table or similar data structure. When STA 105-1 roams to a total of M APs (e.g., AP 110-1, AP 110-2, and AP 110-3), a total of M mappings 320 may be saved, with each mapping associating the MAC address of a respective AP with its corresponding PTK. The cache table ensures that STA 105-1 can quickly identify the proper PTK to use when communicating with a specific AP.

FIG. 3B depicts an example SMD 300B where a roam-specific MAC address is included in a roaming request 325 and a per-AP PTK is established during an initial association and reused to protect the roaming request, according to some embodiments of the present disclosure.

Unlike FIG. 3A, where only the roaming-specific address is used, FIG. 3B introduces an additional layer of mapping by including the DS MAC address within the roaming request. The DS MAC address serves as an intermediate identifier between the roaming-specific MAC address (RMA) and the PTK. Since the DS MAC address remains stable across multiple roaming events, it can act as a consistent reference point for security mappings. Therefore, the use of the DS MAC address improves the system's ability to manage frequent changes to the roaming-specific MAC address.

As depicted, STA 105-1 initially associates with AP 110-1 and, during the association process 305-2 (e.g., via the 4-way handshake), exchanges both its DS MAC address and one or more RMAs (e.g., RMA₁ to RMAₙ). In some embodiments, the STA generates the RAMs and transmits them in EAPOL M2 or M4. In other embodiments, the RMAs are assigned by AP 110-1 and sent in EAPOL M1 or M3. In some embodiments, the RMAs may be included within a (re)association request (e.g., (Re)Association Request frames or Link Reconfiguration Request frames).

As depicted, two mappings are established: an address mapping 330 (also referred to in some embodiments as a TA-DS MAC mapping) that associates roaming-specific addresses (e.g., RMA₁ to RMAₙ) included within the TA field with the DS MAC address, and a PTK mapping 335 (also referred to in some embodiments as a DS MAC-PTK mapping) that associates the DS MAC address with the PTK 1. Both mappings are stored locally by AP 110-1. The established PTK 1 (310) is unique to the specific AP-STA pair, and can only be used for communications between STA 105-1 and AP 110-1.

Similarly, STA 105-1 generates a RA-PTK mapping 320, which associates the MAC address of the AP 110-1 (e.g., included within the RA field) with PTK 1. When STA 105-1 roams to AP 110-2, as depicted, it sends a roaming request 325 (e.g., a Reassociation Request frame or a Link Reconfiguration Request frame) to AP 110-1. If the RMAs are STA-assigned, the roaming request 325-3 includes the current RMA (e.g., one of RMA₁ to RMAₙ) and one or more future RMAs (e.g., RMAₙ₊₁ to RMAₙ₊ₘ). In some embodiments, the future RMAs are sent when the current communicated RMAs (e.g., RMA₁ to RMAₙ) are nearing expiration or have been consumed due to previous roaming events. In embodiments where the RMAs are AP-assigned, the roaming request 325-4 may only include the current RMA (e.g., one of RMA₁ to RMAₙ). The AP 2 includes a new RMA set in the roaming response (not shown).

Because the per-AP PTK model is used and AP 110-1 does not share its address and PTK mappings with AP 110-2, AP 110-2 and STA 105-1 initiate a new 4-way handshake to establish a new key, PTK 2. After the handshake, AP 110-2 generates two new local mappings: an address mapping 345 (also referred to in some embodiments as a TA-DS MAC mapping) that associates the received RMAs (e.g., RMA₁ to RMAₙ₊ₘ) with the DS MAC address of STA 105-1, and a PTK mapping (also referred to in some embodiments as a DS MAC-PTK mapping) that associates the DS MAC address with PTK 2 (not shown). STA 105-1 also updates its own RA-PTK mapping 320 to associate the MAC address of AP 110-2 with PTK 2.

To facilitate future roaming, as depicted, AP 110-2 shares the address mapping 345 (but not the PTK mapping) with other APs in the SMD, either directly or via the WLC 115. This allows, for example, AP 110-1 to update its own address mapping 330 to reflect the next RMAs (e.g., RMAₙ₊₁ to RMAₙ₊ₘ). The update enables AP 110-1 to recognize STA 105-1 in the event that STA 105-1 roams back to AP 110-1 using the new RMAs.

Later, as depicted, if STA 105-1 decides to roam back to AP 110-1 (e.g., due to increased signal strength or movement back into AP 110-1's coverage), STA 105-1 sends a roaming request 340 to AP 110-1. The roaming request 340 is PMF-protected using PTK 1. In preparing the request 340, STA 105-1 checks its RA-PTK mapping 320 and retrieves PTK 1. If the next RMA in the sequence is RMA₂, the STA 105-1 includes RMA₂ in the request 340. If RMA₂ to RMAₙ have been used or expired due to roaming events or timeouts, the STA 105-1 includes RMAₙ₊₁ within the request 340. Upon receiving the request 340, AP 110-1 extracts the current RMA and use its updated address mapping 330 to resolve the DS MAC address of STA 105-1. AP 110-1 then retrieves PTK 1 from the PTK mapping 335 and uses it to verify the MIC attached to the roaming request 340. If the computed MIC matches, AP 110-1 authenticates STA 105-1 and sends a roaming response (e.g., a Reassociation Response frame or a Link Reconfiguration Response frame) to complete the handover. In embodiments where the STA generates the RMAs, the STA may additionally include one or more future RAMs (e.g., RAMₙ₊ₘ₊₁ to RMA ₙ₊ₘ₊ₚ) in the request 340.

In some embodiments, the one or more next RMAs included in the roaming request may be used exclusively for communication between the STA and a specific AP, rather than across the entire SMD. For example, the RMAₙ₊₁ to RMAₙ₊ₘ included in the request 325 may be used for AP 110-2 and mapped to PTK 2. In this configuration, there is no need for AP 110-2 to share the received RMAs with other APs. Instead, AP 110-2 can update its local mappings to associate the received RMA (e.g., RMAₙ₊₁ to RMAₙ₊ₘ) to PTK 2.

The APs 110, as depicted in FIGS. 2A-2B and 3A-3B, are configured to check when the RMAs are provided by a STA. This check ensures that each RMA does not conflict with any existing MAC address of devices in the SMD. The conflict detection is to avoid ambiguity in STA identification and ensure that the correct PTK can be retrieved during roaming. If a conflict is detected, the AP 110 may send back a response (e.g., a Reassociation Response frame or a Link Reconfiguration Response frame), granting the association but with a status code indicating a warning or address conflict (e.g., “ADDRESS_CONFLICT”). In such a configuration, the AP 110 may also send a message indicating an address conflict (e.g., using a status code such as “ADDRESS_CONFLICT”). In response to the conflict, the AP 110 may either assign one or more new RMAs to the STA or request the STA to provide one or more new RMAs. The AP 110 again verifies the updated address, and if no conflict is found, the AP 110 updates the TA-PTK mapping (or TA-DS MAC mapping in FIGS. 2B and 3B) to reflect the new RMAs.

In some embodiments, the RMAs, as depicted in FIGS. 2A-2B and 3A-3B, may be assigned by the AP 110-1 to the STA 105-1 instead of being generated by the STA 105-1. In this configuration, the AP 110-1 may transmit the assigned RMAs (e.g., RMA₁ to RMAₙ) to the STA 105-1 using the EAPOL M3 or an IRM Action frame. This allows the STA 105-1 to adopt the addresses for the subsequent roaming-related communications.

In some embodiments, the assigned or agreed upon RMAs, as depicted in FIGS. 2A-2B and 3A-3B, may be included within the TA field in all roaming-related messages exchanged between a STA and a target AP (where the associated AP and the target AP are within the same SMD or Extended Service Set (ESS)). These roaming-related messages may include the (Re)Association Request/Response frame, Link Reconfiguration Request/Response frame, or Add Link/Delete Link Request/Response frame. In some embodiments, the assigned or agreed upon RMAs may be included within the TA field in any management frames (whether protected or unprotected) exchanged between a STA and a target AP, and are not limited to only roaming-related messages. The extended use of RMA as a consistent identifier across control and management exchanges helps APs 110 to correctly recognize the STA and maintain accurate PTK association.

The roaming-specific MAC address (RMA) described in the present disclosure is different from the regular randomized MAC address (e.g., IRM) used in 802.11bi/bh operations. The regular randomized MAC address is periodically changed at defined epoch boundaries and is used for general communication, such as uploading and downloading data through an AP, as well as facilitating local or remote network interactions with other devices. In contrast, the roaming-specific MAC address is used specifically for roaming events. The roaming-specific MAC address serves as a temporary and targeted identifier that allows a target AP to retrieve a previously established PTK for secure handover.

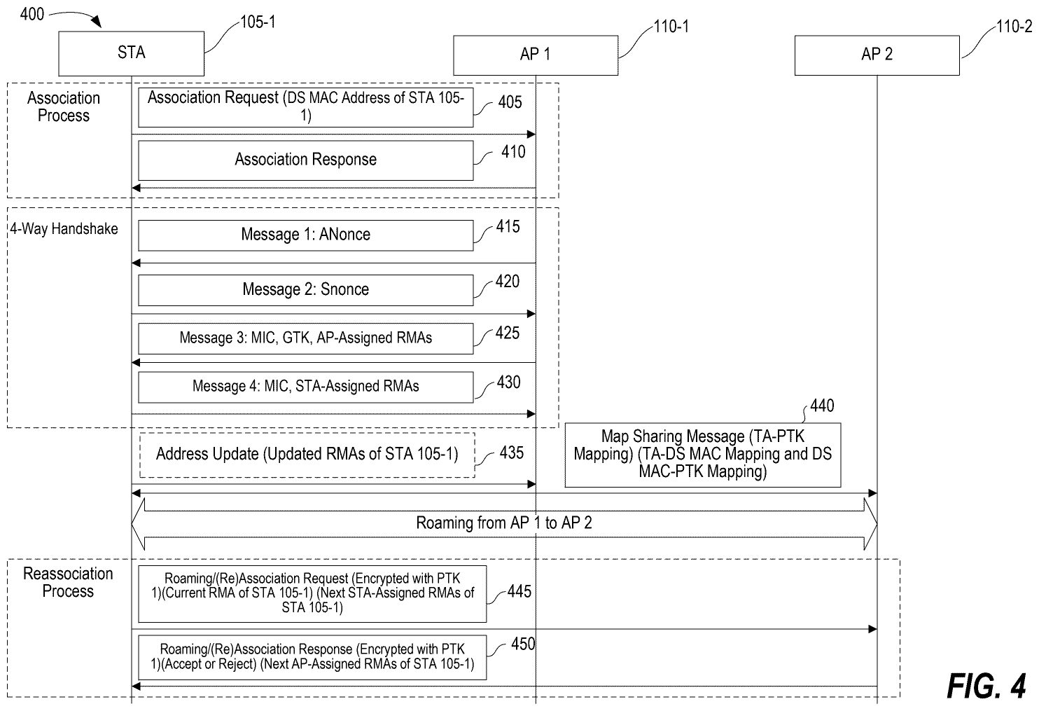

FIG. 4 depicts an example sequence of interactions 400 between a STA 105-1 and two APs 110-1 and 110-2, where the STA 105-1 roams from one AP to another using a shared PTK, according to some embodiments of the present disclosure.

The STA 105-1 corresponds to the STA 105-1 as depicted in FIGS. 1 and 2A-2B. The AP 110-1 and AP 110-2 correspond to the AP 110-1 and AP 110-2 as depicted in FIGS. 1 and 2A-2B, respectively. AP 110-1 and AP 110-2 belong to the same SMD and are controlled by a backend infrastructure (e.g., WLC 115 of FIG. 1).

As depicted, the interaction begins with an association process. STA 105-1 sends an association request 405 (e.g., via an Association Request frame) to AP 110-1, indicating the STA's intent to connect. If DS MAC-based mapping is used (as depicted in FIGS. 2B and 3B), the DS MAC address of the AP 110-1 may be included in the initial request. As depicted, AP 1 responds with an association response 410, approving or rejecting the request based on local policy.

With the association approved and completed, the STA 105-1 and AP 110-1 proceed with the 4-way handshake to establish a PTK (e.g., PTK 1).

After the association is acknowledged, STA 105-1 and AP 110-1 proceed to perform a 4-way handshake to establish the PTK (e.g., PTK 1). As part of the handshake, AP 110-1 first sends a Message 1 (as depicted by 415) to STA 105-1. The Message 1 includes an ANounce (which is a random number generated by the AP 110-1). The Message 1 initiates the handshake and allows the STA 105-1 to generate the PTK. Second, STA 105-1 uses the ANounce to compute PTK (e.g., PTK 1) and sends a Message 2 (as depicted by 420) to AP 110-1. The Message 2 includes a SNounce (which is a random number generated by the STA 105-1) and a MIC. The AP 110-1 uses the ANounce and SNounce to compute the PTK (e.g., PTK 1). Third, AP 110-1 sends a Message 3 (as depicted by 425) that confirms the PTK and includes a MIC. The Message 3 indicates that the AP 110-1 has successfully computed the PTK and is ready to proceed. In embodiments where the AP 110-1 is assigning the RMAs, Message 3 includes one or more AP-assigned RMAs (e.g., RMA₁ to RMAₙ) that the STA may use in future roaming-related communication. In Message 4 (as depicted by 430), STA 105-1 acknowledges the handshake. If the STA 105-1 is configured to assign RMAs, then Message 4 includes one or more STA-assigned RMAs (e.g., RMA₁ to RMAₙ). Since these addresses are generated by the STA, there is a possibility of address conflicts within the SMD. As a result, upon receiving M4, AP 110-1 may perform a conflict check against its local or centralized address table. If any conflict is detected, AP 110-1 may send a response to STA 105-1, indicating the conflict status (e.g., using a predefined status code like “ADDRESS_CONFLICT”). In response to the conflict, the AP 110-1 may assign one or more new RMAs to the STA 105-1, or the STA 105-1 may provide one or more updated RMAs to the AP for verification (as depicted by 435).

In some embodiments, the AP-assigned RMAs may be provided within M1 or in a (re)association response. In some embodiments, the STA-generated RMAs may be provided within M2 or in a (re)association request.

Once the PTK is established, AP 110-1 generates a TA-PTK mapping (e.g., 215 of FIG. 2A) that associates the received RMAs of STA 105-1 with PTK 1. In embodiments where a DS MAC address is included, the AP 110-1 may generate a TA-DS MAC address mapping (e.g., 230 of FIG. 2B) and a DS MAC-PTK mapping (e.g., 235 of FIG. 2B). Since the PTK is derived based on the DS MAC address of the STA 105-1, and the RMA is used for the roaming-specific purpose, a full PTK rekeying process may not be needed. Instead, AP 110-1 may simply update the mapping to associate the updated RMAs with the established PTK 1. These mappings are then shared by AP 110-1 with the backend infrastructure, such as the WLC (e.g., 115 of FIGS. 2A and 2B), which either receives and distributes the mapping data to other APs in the SMD, including AP 110-2 (as depicted by 440), or stores the mapping data in a centralized database for future query-based retrieval. In some embodiments, the mappings may also be shared directly with other APs using action frames or other OTA management frames.

After the 4-way handshake is completed and the PTK is established, AP 110-1 and STA 105-1 begin data exchange. The STA 105-1 and AP 110-1 use the PTK 1 to encrypt and decrypt data frames for secure communication. During this phase, the STA 105-1 monitors the RSSI and other relevant indicators (e.g., signal quality, latency, or packet loss) to determine when to initiate a roaming event.

When STA 105-1 moves away from AP 110-1, detects a sudden RSSI drop, or encounters other relevant factors indicating that AP 110-1 is no longer suitable for communication, it may decide to roam to another AP in the SMD. In the depicted scenarios, AP 110-2 is selected as the target AP. To initiate the roaming (or reassociation) process, STA 105-1 sends a roaming request 445 (e.g., a Reassociation Request frame) to AP 110-2. The roaming request is protected using PTK 1. In embodiments where the STA assigned the RMAs, the request 445 includes the current RMA (e.g., one of RMA₁ to RMAₙ) and optionally one or more future RMAs (e.g., RMAₙ₊₁ to RMAₙ₊ₘ). The target AP (AP 2) performs a conflict check to ensure that the provided RMAs do not conflict with any existing MAC addresses in the SMD. If no conflict is detected, the target AP updates its mapping to associate the RMAs with the existing PTK 1 and shares the updated mapping with other APs in the SMD. In embodiments where the AP assigned the RMAs, the response 450 includes only the current RMA, and the roaming response 450 from AP 110-1 includes the next set of AP-assigned RMAs.

Upon receiving the request 445, AP 110-2 uses the current RMA (e.g., RMA₁) to check the shared TA-PTA mapping (or TA-DS MAC mapping and TA-DS MAC mapping) and retrieves PTK 1. With PTK 1, AP 110-2 computes its own MIC and compares it with the MIC attached to the roaming request to determine the integrity of the message. If the computed MIC matches the attached MIC, the request is considered valid, and AP 110-2 authenticates STA 105-1. Based on the result of the MIC verification, AP 110-2 sends a roaming response 450 (e.g., a Reassociation Response frame or a Link Reconfiguration Response frame) to STA 105-1, either approving or rejecting the reassociation. If the request is valid, the reassociation is approved, and the STA 105-1 transitions to AP 110-2. If the request is invalid, the reassociation is rejected. The response 450 may also be encrypted using PTK 1 for secure communication.

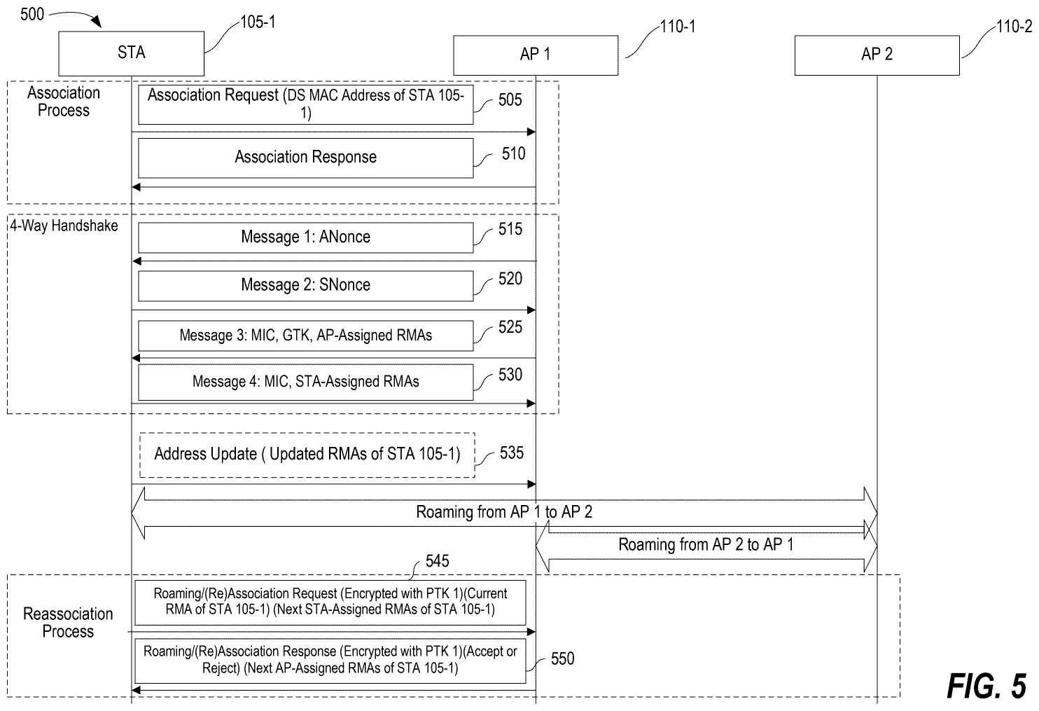

FIG. 5 depicts an example sequence of interactions 500 between a STA 105-1 and two APs 110-1 and 110-2, where the STA 105-1 roams between the two APs using different PTKs, according to some embodiments of the present disclosure.

The STA 105-1 corresponds to the STA 105-1 as depicted in FIGS. 1 and 3A-3B. The AP 110-1 and AP 110-2 correspond to the AP 110-1 and AP 110-2 as depicted in FIGS. 1 and 3A-3B, respectively. AP 110-1 and AP 110-2 belong to the same SMD and are controlled by a backend infrastructure (e.g., WLC 115 of FIG. 1).

As depicted, in the initial association phase, STA 105-1 sends an association request 505 (e.g., an Association Request frame) to AP 110-1. The request indicates the STA's intent to associate with AP 110-1. If DS MAC-based mapping is used (as depicted in FIGS. 2B and 3B), the DS MAC address of the AP 110-1 may be included in the initial request. AP 110-1 responds with an association response 510, either approving or rejecting the request based on defined association policies.

As depicted, STA 105-1 and AP 110-1 proceed to perform a 4-way handshake to establish a PTK (e.g., PTK 1). The 4-way handshake involves four messages exchanged between the STA 105-1 and AP 110-1. Message 1 (as depicted by 515) is sent by AP 110-1 to STA 105-1, including an ANounce. STA 105-1 uses the ANounce to compute PTK and sends a Message 2 (as depicted by 520) to AP 110-1. The Message 2 includes a SNounce and a MIC. Message 3 (as depicted by 525) is sent by AP 110-1 to STA 105-1, confirming the PTK and including a MIC. Finally, the STA 105-1 sends a Message 4 (as depicted by 530), acknowledging the PTK. In embodiments where AP 110-1 is configured for RMA assignment, Message 3 includes one or more AP-assigned RMAs (e.g., RMA₁ to RMAₙ). The AP 110-1 ensures that the assigned RMAs are conflict-free and unique within the SMD. If STA 105-1 is configured for RMA assignment, Message 4 includes one or more STA-assigned RMAs (e.g., RMA₁ to RMAₙ). Since STA-assigned RMAs have the potential to conflict with existing addresses within the SMD, AP 110-1, upon receiving M4, may perform a conflict check against its local or centralized address table. If any conflict is detected, AP 110-1 may send a response to STA 105-1 indicating the conflict status (e.g., using a predefined status code such as “ADDRESS_CONFLICT”). In response, the AP 110-1 may assign one or more new RMAs to the STA 105-1, or the STA 105-1 may provide one or more updated RMAs to the AP for verification (as depicted by 435).

In some embodiments, the AP-assigned RMAs may be provided within M1 or in a (re)association response. In some embodiments, the STA-generated RMAs may be provided within M2 or in a (re)association request.

After the PTK is established, AP 110-1 generates a TA-PTK mapping (e.g., 315 of FIG. 3A) that associates the RMA of STA 105-1 with PTK 1. In embodiments where a DS MAC address is included, the AP 110-1 may generate a TA-DS MAC address mapping (e.g., 330 of FIG. 3B) and DS MAC-PTK mapping (e.g., 335 of FIG. 3B). Additionally, STA 105-1 generates a RA-PTK mapping (e.g., 320 of FIGS. 3A and 3B) that associates the MAC address of AP 110-1 with PTK 1. In embodiments where the initially provided RMAs conflict with existing addresses and the updated RMAs are received afterward, AP 110-1 may update its address mappings accordingly. More specifically, once the updated RMAs are verified to be non-conflicting, AP 110-1 updates the TA-PTK mapping (or TA-DS MAC mapping) to reflect the new RMAs.

After the 4-way handshake is completed and the PTK is established, AP 110-1 and STA 105-1 begin data exchange. The STA 105-1 and AP 110-1 use the PTK 1 to encrypt and decrypt data frames for secure communication. During this phase, the STA 105-1 monitors the RSSI and other relevant indicators (e.g., signal quality, latency, or packet loss) to determine when to initiate a roaming event.

As depicted, STA 105-1 transitions from AP 110-1 to AP 110-2. This may occur when STA 105-1 detects a sudden RSSI drop or encounters other relevant factors indicating that AP 110-1 is no longer suitable for communication. To initiate the roaming process, STA 105-1 sends a roaming request (e.g., a Reassociation Request frame) (e.g., 325 of FIGS. 3A-3B) to AP 110-2 (not shown). The roaming request may include both the currently used roaming-specific MAC address (e.g., RMA₁) and one or more next RMAs (e.g., RMAₙ₊₁ to RMAₙ₊ₘ). Since this configuration uses a per-AP PTK approach, the previously established PTK 1 with AP 110-1 cannot be reused by AP 110-2. As a result, a full authentication process is performed, including a 4-way handshake, to establish a new PTK (e.g., PTK 2) specific to the pair of STA 105-1 and AP 110-2.

After PTK 2 is established, AP 110-2 may generate local mappings, such as a TA-PTK mapping (e.g., 315 of FIG. 3A) or a TA-DS MAC address mapping (e.g., 330 of FIG. 3B) and a DS MAC-PTK mapping (e.g., 335 of FIG. 3B) when DS MAC is provided in the roaming request. AP 110-2 may then share the updated address information or the TA-DS MAC mapping with other APs in the same SMD. The sharing may occur via a backend controller (e.g., WLC 115 of FIGS. 3A-3B) or OTA using management frames. By distributing the information, other APs in the SMD can update their address mappings so that these APs can recognize and authenticate STA 105-1 during the next roaming event.

As depicted, after associating with AP 110-2 for a period of time, STA 105-1 may detect that AP 110-1 is again preferable, such as due to improved signal strength or reduced latency. In this configuration, the STA 105-1 decides to roam back to AP 110-1. Since PTK 1 was previously established between STA 105-1 and AP 110-1, the STA 105-1 can reuse PTK 1 to protect the roaming request 540.

As depicted, STA 105-1 sends a roaming request 540 (e.g., a Reassociation Request frame or a Link Reconfiguration Request frame) to AP 110-1, using the RMA as the roaming-specific address. The roaming request is protected using PTK 1. Upon receiving the request, AP 110-1 uses the current RMA (e.g., RMA₂) to retrieve PTK 1 from its local TA-PTK mapping (or its local TA-DS MAC mapping and TA-DS MAC mapping). AP 110-1 then uses PTK 1 to compute its own MIC and compares it with the MIC attached to the roaming request. If the MIC matches, the request is considered valid, and the AP 110-2 sends a roaming response 550 (e.g., a Reassociation Response frame or a Link Reconfiguration Response frame) to approve the reassociation. If the MIC does not match, the request is considered invalid, indicating that the request may be compromised or from an unauthorized entity. The AP 110-2 sends a response 550 to reject the reassociation.

In embodiments where the STA generates the RMAs, the STA 1 may provide one or more new RMAs for future roaming events in the roaming request 545. The target AP (AP 1) then performs a conflict check to ensure that the provided RMAs do not conflict with any existing MAC addresses in the SMD. If no conflict is detected, the target AP updates its mapping to associate the RMAs with the existing PTK 1 and shares the updated address information with other APs in the SMD.

In some embodiments, the roaming-specific MAC address may be assigned by the AP 110-1 to the STA 105-1, instead of being proposed by the STA 105-1. The assigned address may be sent to the STA either within the Association Response frame (e.g., 410 of FIG. 4 or 510 of FIG. 5) or as part of the 4-way handshake, such as within M1 or M3 (e.g., 425 of FIG. 4 or 525 of FIG. 5). Because the AP 110-1 is responsible for selecting the roaming-specific address, an inherent address conflict check may be performed, and the address update (e.g., 435 of FIG. 4 or 535 of FIG. 5) may be omitted. The AP 110-1 can guarantee that the assigned address does not conflict with any existing MAC addresses within the SMD. Similarly, in the roaming process, the one or more new RMAs are provided by the target AP within the roaming response (as depicted by 545).

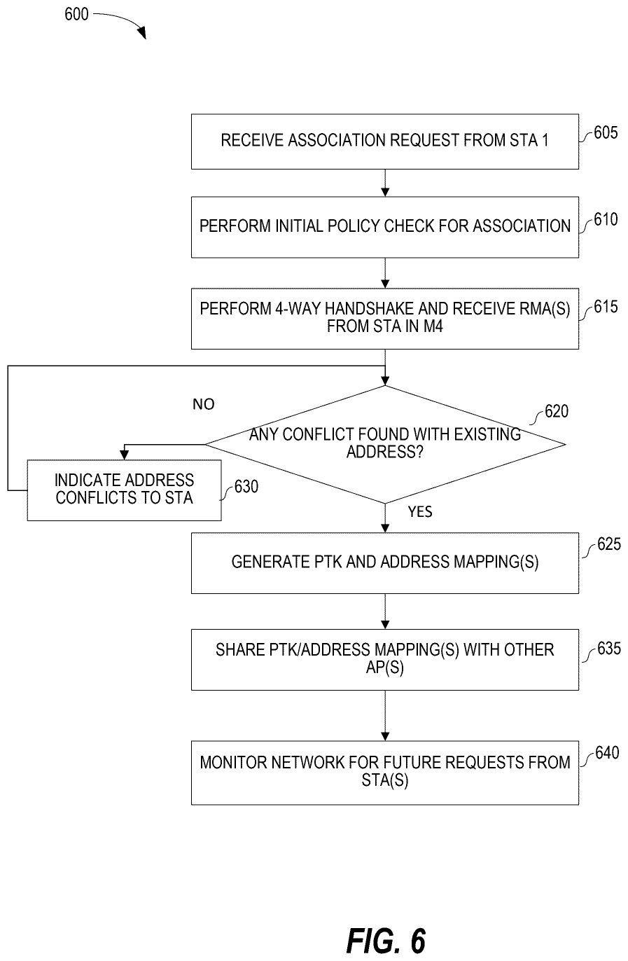

FIG. 6 depicts an example method 600 for a first AP (AP 1) handling an initial association and sharing PTK mappings with other APs in the same SMD, according to some embodiments of the present disclosure. The example method 600 may be performed by an AP, which can be either a single-link AP or multi-link AP, such as AP 1 (110-1) as depicted in FIGS. 1, 2A-2B, and 4. The example method 600 enables the AP to process an association request from a STA, generate a PTK, and establish a PTK mapping for seamless roaming within an SMD.

At block 605, a first AP (AP 1) receives an association request from a STA (referred to as STA 1 or the first STA hereafter) (e.g., 105-1 of FIGS. 2A and 2B). The request (e.g., 205-1 of FIG. 2A) includes the STA's intent to connect. In embodiments where DS MAC-based mapping is used (as depicted in FIGS. 2B and 3B), the association request may further include the DS MAC address of STA 1.

At block 610, the first AP (AP 1) evaluates the STA's eligibility based on internal policy rules. These checks may include validating supported PHY/MAC capabilities, checking authentication state, verifying access control lists, and preparing resources for data transmission (e.g., memory, airtime, and bandwidth). These checks determine whether the AP 1 can accept the association request and proceed with the security handshake process. If satisfied, AP 1 sends an association response to STA 1 approving the association.

At block 615, AP 1 begins the 4-way handshake with STA 1. During the process, AP 1 sends Message 1 (M1) that includes ANonce. STA responds with Message 2 (M2) that includes SNonce and a MIC using the derived PTK. With the ANonce and SNonce, both AP 1 and STA 1 independently derive the same PTK. AP 1 then sends Message 3 (M3), which includes a GTK, a replay counter, and a MIC to confirm successful PTK derivation. STA 1 replies with Message 4 (M4) to acknowledge the handshake completion. The M4 further includes one or more RMAs (e.g., RMA₁ to RMAₙ) for subsequent roaming events. In some embodiments, the STA-generated RMAs may be included within M2 or in a (re)association request.

In configurations where DS MAC mapping is supported (as depicted in FIGS. 2B and 3B), the DS MAC address of STA 1 may also be included in M4. Following receipt of M4, AP 1 extracts the RMA(s) and the DS MAC address (if needed) and performs a conflict check.

After receiving RMA(s) from STA 1 in M4, at block 620, AP 1 checks for conflicts by comparing the received RMAs against known MAC addresses in the SMD. The conflict detection helps to ensure that the same RMA is not used by multiple devices, which could cause ambiguity in STA identification or PTK retrieval during roaming. The conflict check may be performed using the AP's local cache or by querying a centralized WLC database. If a conflict is detected, the method proceeds to block 630.

At block 625, AP 1 sends a response to STA 1 indicating that the received RMA(s) conflict with existing MAC addresses within the SMD. The message may include a status code (e.g., “ADDRESS_CONFLICT”) to explicitly identify the issue. Upon receiving the conflict notification, STA 1 generates and sends one or more updated RMAs to AP 1 for verification. These new RMAs are transmitted using action frames or other suitable OTA management frames. AP 1 does not complete PTK mapping until a conflict-free RMA set is confirmed. Once the STA 1 provides new RMA(s), the handshake may resume from the MIC verification stage and cycle back to block 620. In some embodiments, when a conflict is detected, AP 1 may assign one or more new RMAs to the STA for use in subsequent roaming events, instead of waiting for the STA to provide new RMAs.

If the RMA(s) are validated as non-conflicting, at block 625, AP 1 finalizes PTK 1 and generates the appropriate mappings. If direct RMA-to-PTK mapping is used, AP 1 creates a TA-PTK mapping (e.g., as depicted in FIG. 2A or 3A). If DS MAC mapping is used, AP 1 generates both a TA-DS MAC mapping and a DS MAC-PTK mapping (e.g., FIG. 2B or 3B).

At block 635, AP 1 shares the generated mapping(s) with other APs in the same SMD. The sharing operation may be completed through a backend controller (e.g., WLC 115) or using protected or unprotected OTA management frames. The shared information ensures that other APs can recognize STA 1 when it roams and retrieve the correct PTK for secure and seamless handover.

At block 640, with PTK 1 established and mapping(s) shared, STA 1 and AP 1 begin secure data exchange. AP 1 also enters a monitoring state to handle future events such as roaming requests from STA 1, mapping updates, or new association attempts from other devices.

In embodiments where the RMA(s) are assigned by AP 1 instead of being provided by STA 1, the conflict check operation at block 620 may be omitted. Since AP 1 is configured to select the roaming-specific MAC address, AP can ensure the assigned RMA(s) do not conflict with any existing addresses within the SMD. In this configuration, AP 1 includes the assigned RMA(s) (e.g., RMA₁ to RMAₙ) in M1 or M3 of the 4-way handshake, or part of a (re)association response. Upon completing the handshake, AP 1 generates the appropriate mapping(s), such as the TA-PTK mapping, or in embodiments with DS MAC addressing, a TA-DS MAC mapping and a DS MAC-PTK mapping, and shares the mapping information with other APs in the SMD, either via a WLC or using direct OTA management frames.

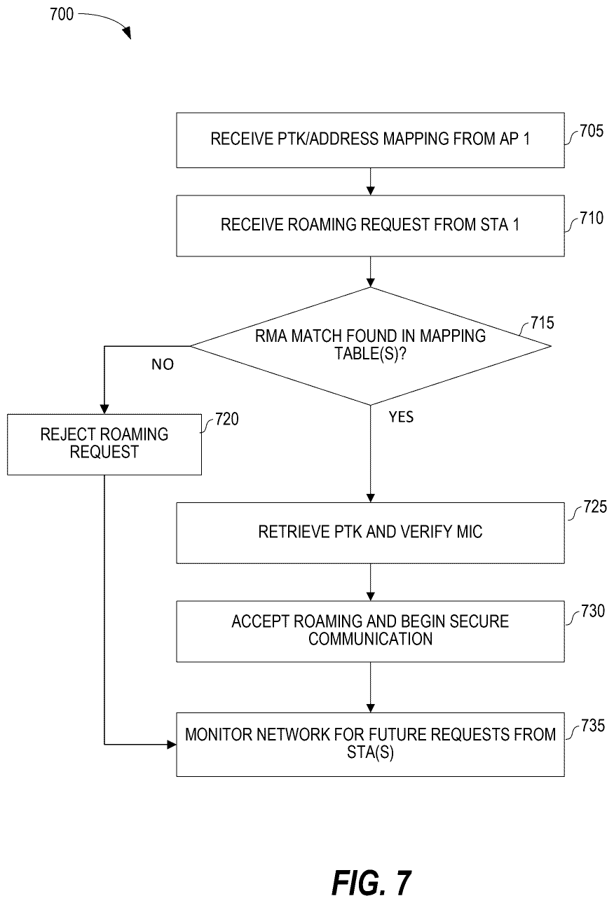

FIG. 7 depicts an example method 700 for a second AP (AP 2) receiving a roaming request and decrypting the roaming request using a shared PTK, according to some embodiments of the present disclosure. The example method 700 may be performed by an AP, which can be either a single-link AP or multi-link AP, such as AP 1 (110-2) as depicted in FIGS. 1, 2A-2B, and 4. The example method 700 enables the AP to process a roaming request from a STA, verify the authenticity and integrity of the request using a shared PTK, and transition the STA without requiring full reauthentication.

At block 705, a second AP (AP 2) receives PTK mappings from a first AP (AP 1). The first and second AP belong to the same SMD and are connected by a WLC or other backend infrastructure (e.g., 115 of FIG. 1). These mappings may include TA-PTK mapping (e.g., 215 of FIG. 2A) (for embodiments where no DS MAC address is used), or TA-DS MAC address mapping (e.g., 230 of FIG. 2B) and DS MAC-PTK mapping (e.g., 235 of FIG. 2B) (for embodiments where a DS MAC address is used). These mappings allow the second AP to identify the STA (e.g., 105-1 of FIG. 1) (referred to as STA 1 or the first STA hereafter) and retrieve the correct PTK when a roaming request is received.

At block 710, the second AP (AP 2) receives a roaming request (e.g., a Reassociation Request frame) from the STA 1 (e.g., 105-1 of FIG. 1). The request is PMF-protected using PTK 1. The TA field of the request includes the roaming-specific MAC address (e.g., RMA₁) assigned to the STA 1. In embodiments where the STA assigns the RMAs, and the current RMAs are approaching expiration or exhaustion, the request may further include one or more next RMAs (e.g., RMAₙ₊₁ to RMAₙ₊ₘ) for use in future roaming events. In embodiments where the AP assigns the RMAs, the roaming request may include only the current RMA (e.g., RMA₁), and the roaming response may include one or more AP-assigned new RMAs for use in subsequent roaming events.

At block 715, the second AP (AP 2) checks whether the received RMA matches an address in its local or shared mapping records. If a matching address is found, the method 700 proceeds to block 720.

At block 720, AP 2 retrieves the corresponding PTK 1 from the shared mapping(s). In embodiments where no DS MAC address is used, the second AP (AP 2) retrieves PTK 1 using the RMA directly. If a DS MAC address is used, the second AP first resolves the RMA to the DS MAC address and then retrieves PTK 1 using the DS MAC mapping.

At block 725, if the MIC matches, AP 2 accepts the roaming request by sending a response (e.g., a Reassociation Response or Link Reconfiguration Response with a success code like “ADDRESS_ACCEPTED”). The response allows the STA to complete the roaming without performing a full 4-way handshake. AP 2 and STA 1 then proceed to secure data exchange using the existing PTK.

If no matching address is found or the MIC verification fails, the method proceeds to block 730. At block 730, AP 2 concludes that the roaming request is invalid or unauthorized. AP 2 sends a rejection response (e.g., a Reassociation Response or Link Reconfiguration Response with a failure code “ADDRESS_NOT_FOUND”), and the method proceeds to block 760.

At block 760, AP 2 continues to monitor the network for future roaming or association requests from STA 1 (which has now been successfully connected to the second AP) or other STAs (which may attempt to connect to the second AP) in the SMD.

In embodiments where a set of next RMAs (e.g., RMAₙ₊₁ to RMAₙ₊ₘ) are provided—either included in the roaming request by the STA in anticipation of RMA expiration or exhaustion, or assigned by AP 2 itself as part of the reassociation response—AP 2 may update its local mapping table accordingly and share the new RMA mappings with other APs in the SMD. In embodiments where a DS MAC address is used, the next RMAs may be associated with the STA's DS MAC address via a TA-DS MAC mapping. AP 2 may then share the updated address mappings with other APs in the same SMD, either directly over the air or through the backend controller.

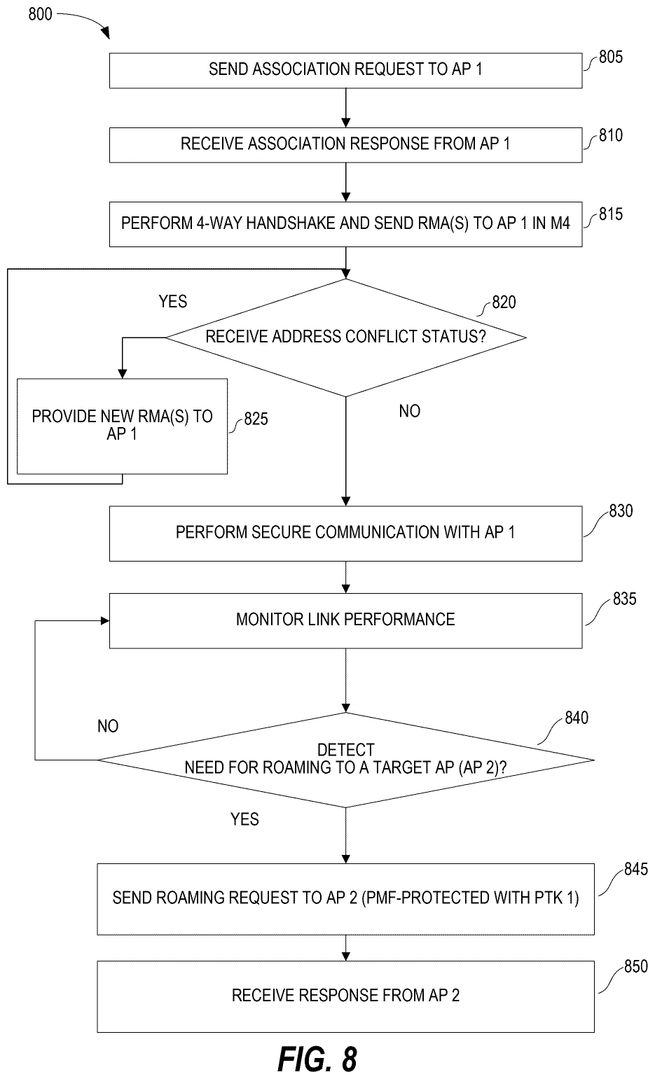

FIG. 8 depicts an example method 800 for a STA performing an initial association with a first AP (AP 1) and roaming to a second AP (AP 2), where the roaming request is protected using a PTK generated and shared by the first AP, according to some embodiments of the present disclosure. The example method 800 may be performed by a client device (STA), which can be either a single-link STA or multi-link STA, such as STA 105-1 as depicted in FIGS. 1, 2A-2B, and 4.

At block 805, a STA (e.g., 105-1 of FIG. 1) (also referred to as STA 1 or the first STA hereafter) sends an association request to a first AP (referred to as STA 1 hereafter) (e.g., AP 110-1 of FIG. 1). The request (e.g., 205-1 of FIG. 2A) indicates the STA's intent to join the network and begin the authentication process. If DS MAC-based mapping is used, the DS MAC address may be included in the initial request.

Upon receiving an association response from the first AP, the STA 1 evaluates the association request based on policy and security rules (e.g., network availability, STA capabilities). If the STA satisfies association conditions, as depicted by block 910, STA 1 receives an association response from STA 1 that approves the association.

At block 815, STA 1 and AP 1 initiate the 4-way handshake to establish a shared PTK. During M1 and M2, the STA 1 and AP 1 exchange nonces and compute PTK 1. In M2 or M4, STA 1 includes one or more STA-assigned RMAs (e.g., RMA₁ to RMAₙ) for use in current and future roaming. In embodiments where DS MAC mapping is used, the STA may also include the DS MAC address in M2 or M4.

Upon receiving M4, AP 1 checks the provided RMAs for address conflicts. If no conflicts are found, AP 1 accepts the RMAs and continues. If any RMA is found to be in conflict with an existing MAC address in the SMD, AP 1 sends a response to STA 1 indicating the conflict (e.g., using a status code like “ADDRESS_CONFLICT”). At block 820, STA 1 checks whether such a conflict notification has been received. If received, the method 800 proceeds to block 825, where the STA 1 generates one or more new RMAs and sends them to AP 110-1 for verification. If no conflict notification is received, the method 800 proceeds to block 830. In some embodiments, when a conflict is found, the AP 1 may assign one or more new RMAs to the STA instead of waiting for the STA to provide new RMAs.

At block 830, after PTK 1 is established and RMAs are accepted (or verified to be conflict-free), STA 1 uses PTK 1 to encrypt and decrypt frames during data exchange with AP 1. Communication continues securely, using the STA-assigned RMAs as roaming-specific identifiers.

At block 835, STA 1 continues to monitor the connection with AP 1 (e.g., RSSI, latency, packet loss). If link performance degrades or another AP becomes preferable, STA 1 prepares to initiate roaming.

At block 840, the STA 1 determines whether it needs to roam to a new AP. Factors that may trigger roaming may include, but are not limited to, decreased RSSI from the first AP, increased packet loss or latency with the first AP, network load balancing, or forced handover by the network. If roaming is desired (or needed), the method 800 moves to block 845. If roaming is not triggered, the method 800 returns to block 835, and the STA 1 continues monitoring the connection with the first AP.

Assuming a second AP (AP 2) (e.g., 110-2 of FIGS. 2A-2B) is selected as the target AP, as depicted, at block 845, the STA 1 sends a roaming request (e.g., 225 of FIGS. 2A and 2B) to the second AP. The request is PMF protected using PTK 1 and includes the current RMA of the STA 1 (e.g., one of RMA₁ to RMAₙ) and one or more next RMAs (e.g., RMAₙ₊₁ to RMAₙ₊ₘ) if the current RMA set is nearing expiration or exhaustion. Upon receiving the request, the second AP retrieves PTK 1 from the shared mappings and verifies the MIC.

At block 850, the STA 1 receives a response from the second AP, which may approve the roaming request (if the MIC verification is successful) or reject the request (if the MIC verification fails).

In embodiments where the roaming-specific MAC address is assigned by the AP, the operation at block 820 may be omitted. Since the RMAs are selected by the AP (e.g., AP 110-1), which has global visibility into the SMD and is configured for conflict avoidance, there is no need to perform additional conflict handling. In this configuration, the AP includes one or more assigned RMAs in M1 or M3 of the 4-way handshake or in a (re)association response. The STA receives the RMAs and adopts them without conflict, and proceeds directly to establishing the PTK. The flow then continues through blocks 835 to 855, during which the STA 1 engages in secure communication with AP 1 using PTK 1, and when roaming is triggered (e.g., due to signal degradation), the STA 1 initiates a roaming request that includes the assigned roaming-specific MAC address. In addition, when one or more new RMAs are provided in the roaming process, these AP-assigned addresses may be included within a roaming response sent by the target AP to the STA 1.

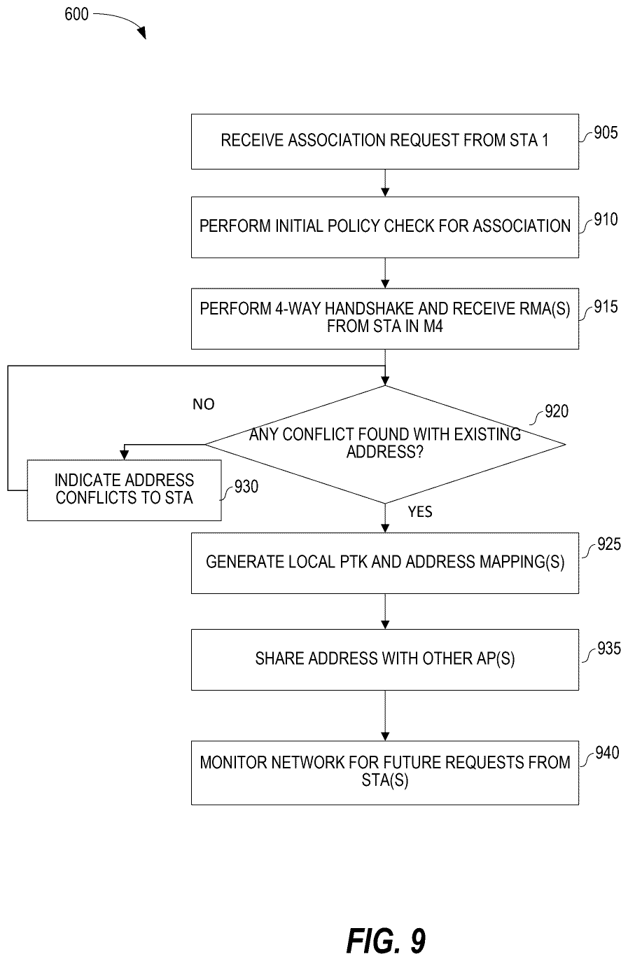

FIG. 9 depicts an example method 900 for a first AP (AP 1) handling an initial association and generating per-AP PTK mappings, according to some embodiments of the present disclosure. The example method 900 may be performed by an AP, which can be either a single-link AP or a multi-link AP, such as AP 1 (110-1) as depicted in FIGS. 1, 3A-3B, and 5. Unlike FIG. 6, where PTK mappings are shared across the SMD, FIG. 9 illustrates a scenario where the PTK is unique to the AP-STA pair and is not shared with other APs.

At block 905, the first AP (AP 1) receives an association request from a STA (referred to as STA 1 or the first STA hereafter) (e.g., 105-1 in FIGS. 3A and 3B). The request (e.g., 305-1 in FIG. 3A) includes the STA's intent to associate. In some embodiments, the request (e.g., 305-2 in FIG. 3B) may also include the DS MAC address of the STA 1.

At block 910, the first AP (AP 1) evaluates policy conditions for association (e.g., capability, load balancing, authentication state). If approved, AP 1 responds with an association response (e.g., an Association Response frame) indicating approval.

At block 915, the first AP (AP 1) and STA 1 perform the 4-way handshake to establish PTK 1. The 4-way handshake involves the exchange of four messages between the AP 1 and STA 1, as discussed in detail with reference to FIG. 5. The PTK 1 here is specific to the AP-STA pair and is used exclusively for secure communication between the STA 1 and the first AP. It is not shared with or used by other APs in the SMD. In embodiments where STA assigns the RMs, AP 1 receives the STA-assigned RMAs (e.g., RMA₁ to RMAₙ) in M4. In configurations where DS MAC mapping is supported, the STA's DS MAC address may also be included in M4. In some embodiments, the STA-generated RMAs may be included within M2 or in a (re)association request.

At block 920, AP 1 extracts the assigned RMAs (and DS MAC if applicable) and performs a conflict check to ensure the RMAs do not overlap with existing MAC addresses in the SMD. If no conflict is detected, the method 900 proceeds to block 925. If a conflict is found, the method 900 moves to block 930.

At block 930, AP 1 sends a message (e.g., an action frame or other OTA management frame) to STA 1 indicating an address conflict using a status code (e.g., “ADDRESS_CONFLICT”). STA 1 responds with one or more updated RMAs. The method 900 cycles back to block 920, where the AP 1 performs conflict resolution again. The process is repeated as needed until a valid, non-conflicting RMA is received. In some embodiments, when a conflict is detected, AP 1 may assign one or more new RMAs to the STA for use in subsequent roaming events, instead of waiting for the STA to provide new RMAs.

At block 925, AP 1 finalizes the PTK (e.g., PTK 1) for secure communication with STA 1. AP 1 generates a TA-PTK mapping that associates the RMA with PTK 1. Unlike in FIG. 6, the mapping is not shared with other APs in the SMD. Instead, it is stored locally on the first AP and used solely for communication with the STA 1 (e.g., 105-1 of FIGS. 3A and 3B). In embodiments where the DS MAC address is provided in the request, the first AP may generate two mappings: an address mapping (e.g., 330 of FIG. 3B) that connects the RMAs to the DS MAC address of the STA 1, and a PTK mapping (e.g., 335 of FIG. 3B) that ties the DS MAC address to PTK 1. Since the established PTK 1 is AP-specific, the PTK mapping is stored locally and not shared with other APs.

At block 935, the first AP (AP 1) shares address information with other APs in the same SMD to enable STA recognition during future roaming events. In configurations where a TA-DS MAC address is generated (e.g., where the STA's DS MAC address is provided and used as a stable identifier), the mapping between the roaming-specific address and the DS MAC address is shared with other APs. Notably, in the per-AP PTK configuration, the PTK established between AP 1 and STA 1 is not shared with other APs. Each AP in the SMD independently establishes its own PTK with the STA via a 4-way handshake.

At block 940, the first AP (AP 1) and STA 1 begin encrypted data communication with STA 1 using the established PTK 1. In parallel, the first AP monitors the network for additional requests from STAs in the SMD, including requests from STA 1 (which is currently associated with the first AP) and/or new STAs (which may attempt to associate with the first AP).

In embodiments where the roaming-specific MAC address is assigned by the first AP, the operation at block 920 may be omitted, since AP 1 assigns an address that is inherently non-conflicting within the SMD. In this configuration, the AP 1 selects RMAs and transmits them to the STA during M1 or M3 of the 4-way handshake, or during the (re)association process. The STA 1 then adopts the assigned RMA for subsequent communication.

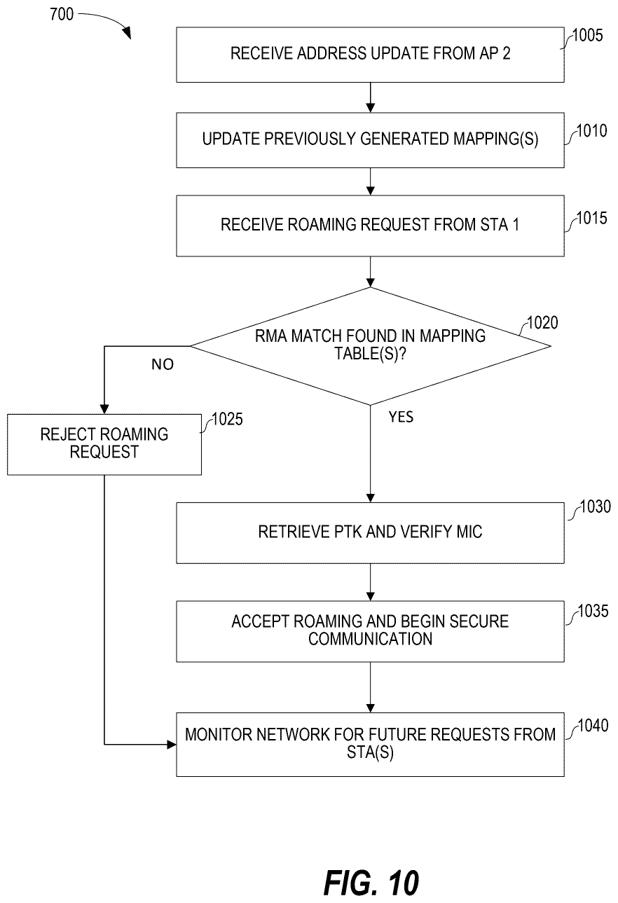

FIG. 10 depicts an example method 1000 for a first AP (AP 1) receiving a roaming request and decrypting the roaming request using a previously established per-AP PTK, according to some embodiments of the present disclosure. The example method 1000 may be performed by an AP, which can be either a single-link AP or multi-link AP, such as AP 1 (110-1) as depicted in FIGS. 1, 3A-3B, and 5. In the disclosed scenario, the first AP (AP 1) has previously been associated with STA 1 (as depicted in FIG. 10), and a PTK (e.g., PTK 1) specific to the AP-STA pair has been established and saved. After AP 1 and STA 1 disconnected—such as when the STA 1 roamed to AP 2 in the SMD—the example method 1000 is performed if the STA 1 now seeks to reconnect to AP 1.

At block 1005, the first AP (AP 1) (e.g., 110-1 of FIGS. 3A-3B) receives an address update including one or more next roaming-specific MAC addresses (e.g., RMAₙ₊₁ to RMAₙ₊ₘ) that STA 1 intends to use in future roaming events. The address update may be received from AP 2 directly or a WLC, after the STA has roamed to AP 2 and provided a new RMA set in its roaming request (e.g., 325 of FIGS. 3A-3B).

At block 1010, the first AP (AP 1) updates its local mappings to reflect the received RMAs (e.g., RMAₙ₊₁ to RMAₙ₊ₘ). This may involve updating a TA-PTK mapping (e.g., 315 of FIG. 3A), where RMAs are directly mapped to PTK 1, or a TA-DS MAC mapping (e.g., 330 of FIG. 3B), where RMAs are associated with the STA's DS MAC address. The update enables AP 1 to recognize and authenticate STA 1 when it later roams back using one of the next RMAs.

At block 1015, the first AP (AP 1) receives a roaming request (e.g., a Reassociation Request frame or a Link Reconfiguration Request frame) from the STA 1 (e.g., 105-1 of FIGS. 3A and 3B), where the TA field includes a current RMA and the roaming request is PMF-protected using PTK 1. The PTK 1 was established during the STA 1's initial association with the first AP. In embodiments where the STA assigns the RMAs, and the current RMAs are approaching expiration or exhaustion, the roaming request may further include one or more next RMAs (e.g., RMAₙ₊₁ to RMAₙ₊ₘ) for use in future roaming events. In embodiments where the AP assigns the RMAs, the roaming request may include only the current RMA (e.g., RMA₁), and the roaming response may include one or more AP-assigned new RMAs for use in subsequent roaming events.

At block 1020, the first AP (AP 1) checks whether the RMA in the request matches any stored mapping entries (e.g., TA-PTK or TA-DS MAC). If a match is found, the method moves to block 1030. If no match is found, the method proceeds to block 1025.

At block 1030, a match is found, and AP 1 retrieves PTK 1 using the current RMA. PTK 1 may be identified by checking a direct TA-PTK mapping, or by resolving the RMA to a DS MAC address and then retrieving the PTK 1 from the DS MAC-PTK mapping. AP 1 computes the MIC over the request payload using PTK 1 and compares it with the MIC included in the request. The check verifies both the authenticity and integrity of the message.

At block 1035, if the MICs match, the roaming request is considered valid, and AP 1 accepts the roaming and resumes secure communication with STA 1 using PTK 1. At block 1040, the AP 1 monitors the network for future roaming or association requests. These may include subsequent requests from STA 1, using one of RMA₂ to RMAₙ, or new requests from other STAs that have not yet been authenticated, in which case a full authentication process (e.g., a 4-way handshake) may be initiated to establish a new PTK.

If no matching address is found or the MIC verification fails, the method proceeds to block 1025. At block 1025, AP 1 concludes that the roaming request is invalid or unauthorized. AP 2 sends a rejection response (e.g., a Reassociation Response or Link Reconfiguration Response with a failure code “ADDRESS_NOT_FOUND”), and the method continues to block 1040, where the AP continues to monitor the network for future roaming or association requests from STA 1 or other STAs in the SMD.

In embodiments where a set of next RMAs (e.g., RMAₙ₊₁ to RMAₙ₊ₘ) are provided-either included in the roaming request by the STA in anticipation of RMA expiration or exhaustion, or assigned by AP 1 itself in the roaming response-AP 1 may update its local mapping to reflect these future addresses. If a DS MAC address is used, AP 1 may associate the new RMAs with the DS MAC address via a TA-DS MAC mapping. AP 1 may then propagate these mappings to peer APs in the same SMD to prepare for future roaming events, either by direct distribution (e.g., using protected management frames) or via the WLC. Notably, while address information is shared, the PTK remains local to AP 1 and is not propagated to preserve the per-AP PTK security model.

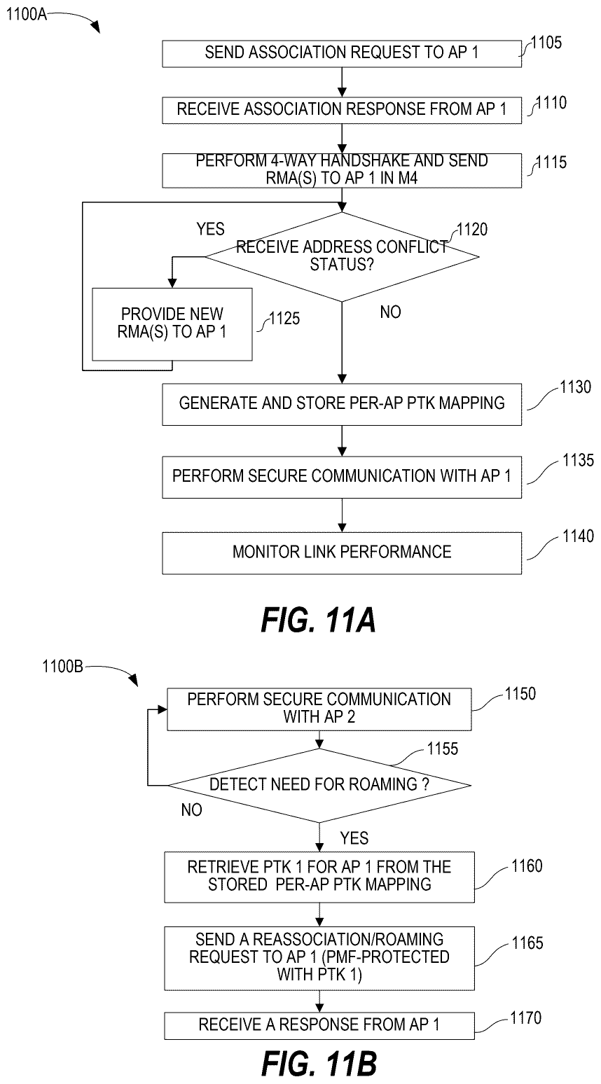

FIG. 11A depicts an example method 1100A for a STA performing initial association with a first AP (AP 1), generating a per-AP PTK mapping, and storing the per-AP PTK mapping for future reassociation, according to some embodiments of the present disclosure. The example method 1100A may be performed by a client device (STA), which can be either a single-link STA or multi-link STA, such as STA 105-1 as depicted in FIGS. 1, 3A-3B, and 5. The depicted method 1100A is performed when the STA associates with the first AP for the first time, and a PTK specific to the AP-STA pair has not yet been established.

At block 1105, a STA (e.g., 105-1 of FIGS. 3A and 3B) (referred to as STA 1 or the first STA hereafter) sends an association request (e.g., an Association Request frame) to the first AP (AP 1) (e.g., 110-1 of FIGS. 3A and 3B). The request indicates the STA's intent to connect to the AP 1. In some embodiments, the request may also include the DS MAC address of STA 1.

At block 1110, the STA 1 receives a response (e.g., an Association Response frame) from AP 1m, indicating whether the association is accepted. If accepted, the STA 1 proceeds to the 4-way handshake to establish a secure session.

At block 1115, STA 1 and AP 1 perform the 4-way handshake to establish PTK 1. More details about the exchange of four messages within the handshake are discussed in detail with reference to FIG. 5. During M2 or M4 of the handshake, the STA 1 provides one or more STA-assigned RMAs (e.g., RMA₁ to RMAₙ). If a DS MAC address is used in the configuration, it may also be included in M2 or M4.

At block 1120, the STA determines whether it has received a response from AP 1 indicating an address conflict (e.g., via a management frame with a status code signaling “ADDRESS_CONFLICT”). Such a conflict indicates that one or more of the submitted RMAs overlaps with existing MAC addresses in the SMD.

If a conflict is detected, the method proceeds to block 1125, where the STA 1 generates new RAMs and resends them to AP 1. The method then cycles back to block 1120 to wait for confirmation of address acceptance. In some embodiments, when a conflict is found, the AP 1 may assign one or more new RMAs to the STA instead of waiting for the STA to provide new RMAs.

If no conflict is reported, the method proceeds to block 1130, where the STA stores a local mapping associating the MAC address of AP 1 with the per-AP PTK (e.g., RA-PTK mapping). The mapping enables the STA to later identify and re-authenticate with AP 1 without repeating a full handshake.

At block 1135, the STA 1 conducts communication with AP 1 using the established PTK. Data exchange between the STA 1 and AP 1 is encrypted based on the agreed session key.

At block 1140, the STA monitors the connection quality, such as RSSI, latency, or error rate. Based on the observed link performance, the STA 1 may decide whether to remain associated with AP 1 or initiate a roaming process to another AP in the SMD.

FIG. 11B depicts an example method 1100B for a STA roaming back to a first AP (AP 1), where the roaming request is protected using a previously generated per-AP PTK for the first AP (AP 1), according to some embodiments of the present disclosure. The example method 1100B may be performed by a client device (STA), which can be either a single-link STA or multi-link STA, such as STA 105-1 as depicted in FIGS. 1, 2A-2B, and 4. The depicted method 1100B is performed when the STA has previously associated with AP 1, and a PTK (e.g., PTK 1) specific to the AP-STA pair has already been established. The roaming request can be verified without requiring a full authentication process.

At block 1150, a STA (e.g., 105-1 of FIGS. 3A and 3B) (referred to as STA 1 or the first STA hereafter) is connected to AP 2 (e.g., 110-2 of FIGS. 3A and 3B) and performs secure communication with AP 2.

At block 1155, the STA 1 monitors network conditions and determines whether it needs to roam to another AP in the SMD, including AP 1. Factors that may trigger roaming include a sudden drop in RSSI from the current AP (AP 2), improved RSSI from another AP (AP 1), network congestion or high latency on the current AP (AP 2), or user movement (where the STA 1 moves out of range of AP 2 and into the coverage area of AP 1).

Assuming the AP 1 is determined as the target AP for roaming, at block 1160, STA 1 checks its stored per-AP RA-PTK mapping to retrieve PTK 1, based on the MAC address of AP 1. At block 1165, STA 1 encrypts the roaming request (e.g., a Reassociation Request frame or a Link Reconfiguration Request frame) and sends it to AP 1. The roaming request includes the current RMA (e.g., RMA₂) in the TA field and may also include one or more next RMAs for use in subsequent roaming events (when the current RMAs are nearing expiration or exhaustion). AP 1, upon receiving the roaming request, verifies its authenticity and integrity using PTK 1. Specifically, AP 1 retrieves PTK 1 from its local mappings (e.g., a TA-PTK mapping or a TA-DS MAC mapping combined with a DS MAC-PTK mapping) and computes the MIC to validate the request. If the computed MIC matches the MIC attached to the request, AP 1 sends a response approving the reassociation. If the MIC does not match, AP 1 rejects the request, indicating an authentication failure.

At block 1170, STA 1 receives a response from AP 1, indicating either an approval or rejection of the reassociation attempt.

In embodiments where the roaming-specific MAC address is assigned by the AP rather than proposed by the STA, the AP 1 includes the assigned RMAs in M1 or M3 of the 4-way handshake or in a (re)association response. Because the AP performs the conflict check prior to assignment, the assigned RMAs are guaranteed to be non-conflicting within the SMD. Accordingly, the operations at block 1120 are not needed in this configuration. Upon receiving the assigned RMAs in M3, the STA proceeds directly to generate the RA-PTK mapping (block 1130) and continues secure communication (block 1135). During the roaming process, since the RMA is assigned by the PA, the roaming request includes only the current RMA being used. In the roaming response, the AP 1 may provide one or more additional AP-assigned RMAs for use in future roaming events.

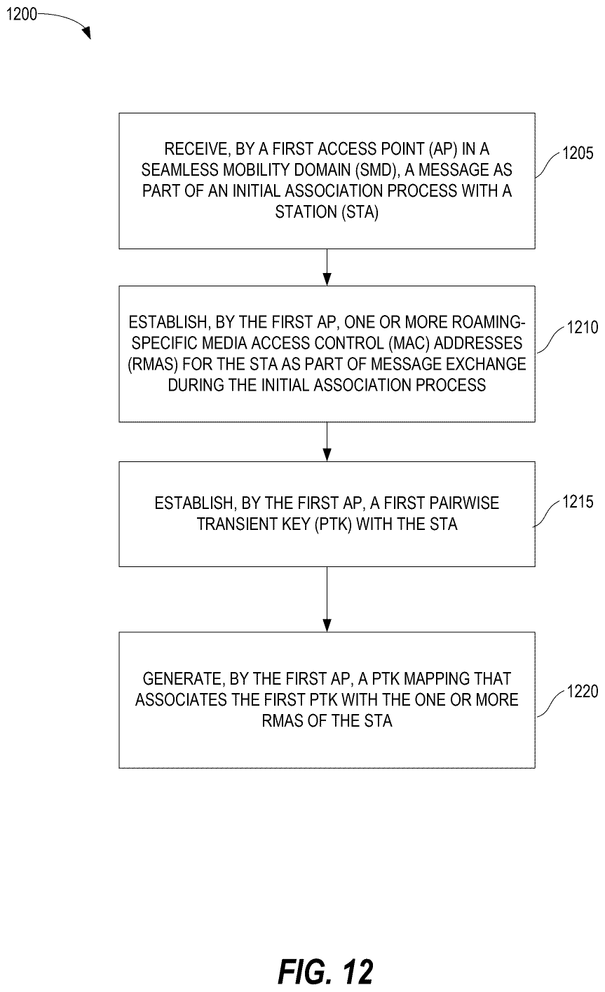

FIG. 12 is a flow diagram depicting an example method 1200 performed by an AP for shared PTK mapping generation, according to some embodiments of the present disclosure.

At block 1205, a first access point (AP) (e.g., AP 110-2 of FIGS. 1, 2A-2B, 3A-3B, 4, and 5) in a seamless mobility domain (SMD) receives a message as part of an initial association process with a station (STA) (e.g., STA 105-1 of FIGS. 1, 2A-2B, 3A-3B, 4, and 5).

At block 1210, the first AP establishes one or more roaming-specific media access control (MAC) addresses (RMAs) for the STA (e.g., RMA₁ to RMAₙ) as part of message exchange during the initial association process;

At block 1215, the first AP establishes a first pairwise transient key (PTK) (e.g., PTK 1 of FIGS. 2A-2B and 3A-3B) with the STA.

At block 1220, the first AP generates a first PTK mapping (e.g., 215 of FIG. 2A, 315 of FIG. 3A) that associates the first PTK with the one or more RMAs.

In some embodiments, the one or more RMAs may be provided by the STA to the first AP in one of an association request, a reassociation request, Message 2 of a 4-way handshake, or Message 4 of the 4-way handshake.

In some embodiments, the one or more RMAs may be assigned by the first AP and provided to the STA in one of an association request, a reassociation request, Message 1 of a 4-way handshake, or Message 3 of the 4-way handshake.

In some embodiments, the first AP may further communicate with the STA using a regular MAC address of the STA (e.g., IRM 140 as depicted in FIG. 1) for data transmission, where the regular MAC address is different from the one or more RMAs.

In some embodiments, the first AP may determine whether the one or more RMAs provided by the STA conflict with existing MAC addresses within the SMD, in response to determining a conflict, provide an RMA collision warning to the STA, and receive, by the first AP, one or more new RMAs from the STA for use in subsequent roaming events.

In some embodiments, the first AP may determine whether the one or more RMAs provided by the STA conflict with existing MAC addresses within the SMD, in response to determining a conflict, provide an RMA collision warning to the STA, and assign one or more new RMAs to the STA for use in subsequent roaming events.

In some embodiments, the first AP may share the PTK mapping with one or more second APs in the SMD, where the PTK mapping comprises the one or more RMAs and the first PTK, and the one or more second APs use the PTK to communicate with the STA.

In some embodiments, the first PTK may be used specifically for communication between the first AP and the STA, and the first AP may share the one or more RMAs with one or more second APs in the SMD, where each of the one or more second APs establishes a respective second PTK with the STA, and maps the shared RMAs to the respective second PTK.

In some embodiments, the second AP, after receiving the shared PTK mapping, is configured to receive a roaming request from the STA as part of a roaming process, the roaming request comprising one of the one or more RMAs and being encrypted using the first PTK, retrieve the first PTK by checking the shared PTK mapping based on a RMA, among the one or more RMAs, within the roaming request, decrypt the roaming request using the first PTK, and send a roaming response to the STA to complete the roaming process.

In some embodiments, the roaming request may further comprise one or more next RMAs for use by the STA in subsequent roaming transitions, and the second AP may be further configured to determine whether the one or more next RMAs conflict with existing MAC addresses within the SMD, and in response to determining a conflict, update the PTK mapping to associate the one or more next RMAs with the first PTK of the STA.

In some embodiments, the second AP may be further configured to assign one or more next RMAs to the STA in a roaming response, and update the PTK mapping to associate the one or more next RMAs with the first PTK.

In some embodiments, the message may further comprise a distribution system (DS) MAC address for the STA. The first AP may generate a PTK mapping that associates the first PTK with the DS MAC address of the STA, and generate an address mapping that associates the DS MAC address with the one or more RMAs.

In some embodiments, the first AP may share the PTK and address mappings with at least one of one or more second APs in the SMD or a wireless controller in the SMD.

In some embodiments, the one or more next RMAs may be encoded within the roaming request as one of a new element added to the roaming request, or a subfield within an existing element of the roaming request.

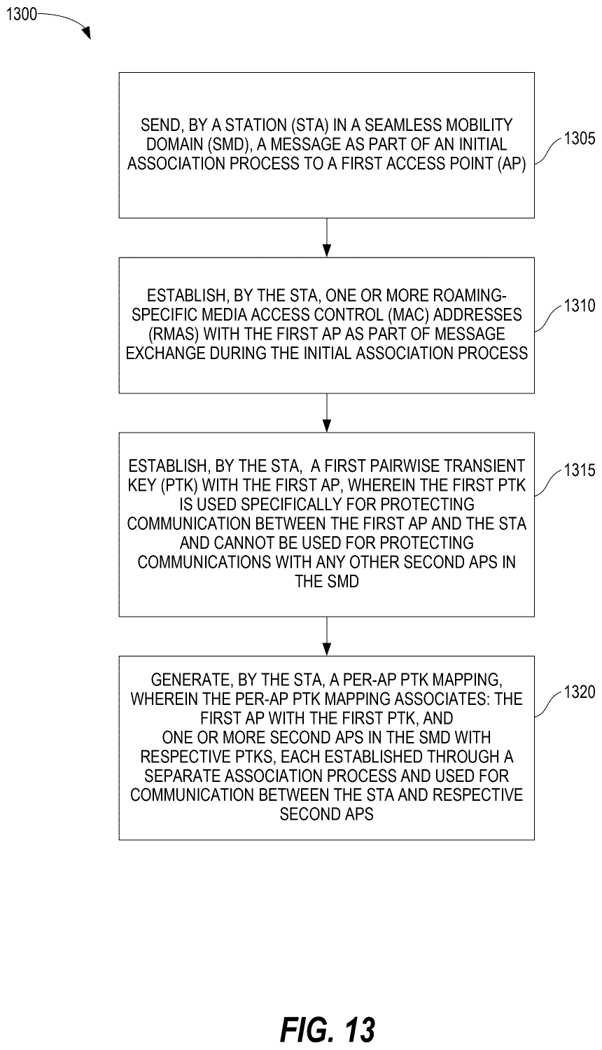

FIG. 13 is a flow diagram depicting an example method 1300 performed by a STA for per-AP PTK mapping generation, according to some embodiments of the present disclosure.

At block 1305, a station (STA) in a seamless mobility domain (SMD) sends a message as part of an initial association process to a first access point (AP).

At block 1310, the STA establishes one or more roaming-specific media access control (MAC) addresses (RMAs) (e.g., RMA₁ to RMAₙ) with the first AP as part of message exchange during the initial association process.

At block 1315, the STA establishes a first pairwise transient key (PTK) with the first AP, where the first PTK is used specifically for communication between the first AP and the STA and cannot be used for communications with any other second APs in the SMD.

At block 1320, the STA generates a per-AP PTK mapping (e.g., 320 of FIGS. 3A-3B), where the per-AP PTK mapping associates the first AP with the first PTK, and one or more second APs in the SMD with respective PTKs, each established through a separate association process and used for communication between the STA and respective second APs.

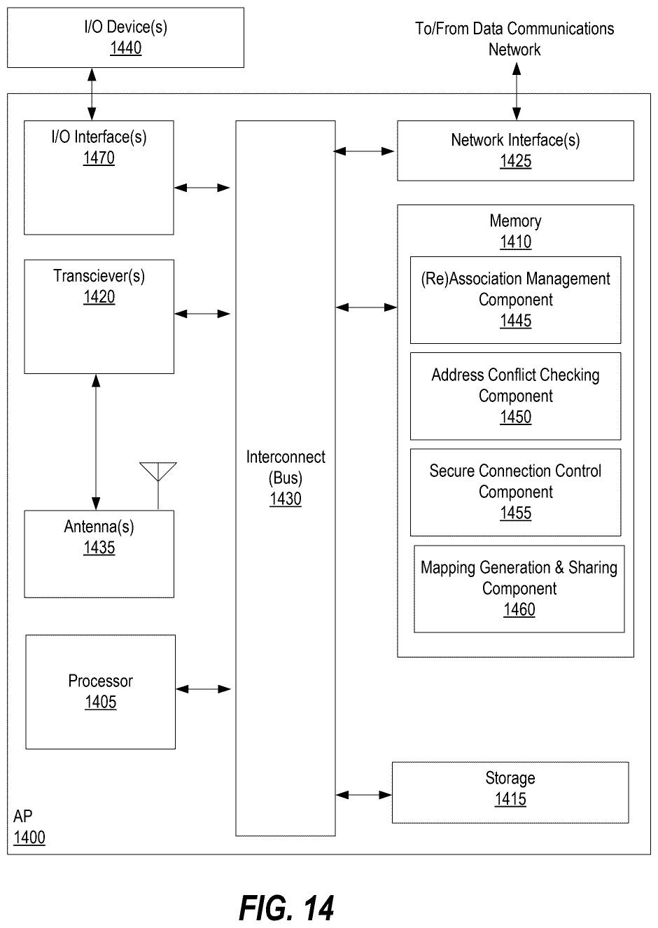

FIG. 14 depicts an example network device 1400 configured to perform various aspects of the present disclosure, according to some aspects of the present disclosure.

In some embodiments, the example network device 1400 may be an AP or any other type of network device (e.g., a router, switch, or network controller) that is capable of supporting the described functionality. In some embodiments, the example network device 1400 may correspond to APs 110 as depicted in FIGS. 1, 2A-2B, 3A-3B, and 4-5.

As illustrated, the example network device 1400 includes a processor 1405, memory 1410, storage 1415, one or more transceivers 1420, one or more I/O interfaces 1480, and one or more network interfaces 1425. In some embodiments, I/O devices 1440 are connected via the I/O interface(s) 1480. Further, via the network interface 1425, the network device 1400 can be communicatively coupled with one or more other devices and components (e.g., via a network, which may include the Internet, local network(s), and the like). Each of the components is communicatively coupled by one or more buses 1430. In some embodiments, one or more antennas 1435 may be coupled to the transceivers 1420 for transmitting and receiving wireless signals.

The processor 1405 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1405 processes information received through the transceiver 1420, I/O interfaces 1480, and the network interfaces 1425. The processor 1405 retrieves and executes programming instructions stored in memory 1410, as well as stores and retrieves application data residing in storage 1415.

The storage 1415 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1415 may store a variety of data for the efficient functioning of the system.

The memory 1410 may include random access memory (RAM) and read-only memory (ROM). The memory 1410 may store processor-executable software code containing instructions that, when executed by the processor 1405, enable the network device 1400 to perform various functions described herein for wireless communication. In the illustrated example, the memory 1410 includes four software components: the address conflict checking component 1445, the (re)association management component 1450, the secure connection control component 1455, and the mapping generation & sharing component 1460.

In one embodiment, the (re)association management component 1445 is configured to manage both initial association and reassociation procedures for connecting STAs. The (re)association management component 1445 coordinates the handling of association requests, exchanges signaling messages (e.g., association responses or reassociation frames), and initiates secure credential setup when association conditions are met. During the reassociation, the (re)association management component 1445 may also retrieve previously established PTKs for validation of protected roaming requests.

In one embodiment, the address conflict checking component 1450 is configured to perform conflict detection for RMAs provided by the STA during association or roaming. Upon receiving a request, the address conflict checking component 1450 determines whether the provided address conflicts with any existing MAC address in the SMD. If a conflict is detected, the component 1450 notifies the (re)association management component for further resolution.

In one embodiment, the secure connection control component 1455 is configured to manage the 4-way handshake process to establish a PTK between the network device 1400 and a STA. In one embodiment, the PTK generated may be shared with other APs in the SMD via a WLC or direct AP-to-AP communication. When the STA roams from AP 1 to AP 2, the new AP can retrieve the same PTK without requiring a full reauthentication process. In some embodiments, each AP generates its own PTK independently. Since AP 2 does not receive PTK 1 from AP 1, it cannot decrypt the roaming request unless a new handshake is completed. In this configuration, STA is required to maintain a PTK mapping table, tracking which PTK corresponds to each AP it has been associated with.

In one embodiment, the mapping generation and sharing component 1460 is configured to generate and maintain PTK mappings, and share these mappings with other APs in the SMD. When the 4-way handshake completes, the component 1460 creates a mapping that associates the STA's identifier with the generated PTK. In embodiments where the DS MAC address is used, the component 1460 may generate an address mapping that associates the roaming-specific address to the DS MAC address, as well as a PTK mapping that links the PTK DS MAC address to the established PTK.

Although depicted as a discrete component for conceptual clarity, in some embodiments, the operations of the depicted components (and others not illustrated) may be combined or distributed across any number of components. Further, although depicted as software residing in memory 1410, in some aspects, the operations of the depicted components (and others not illustrated) may be implemented using hardware, software, or a combination of hardware and software.

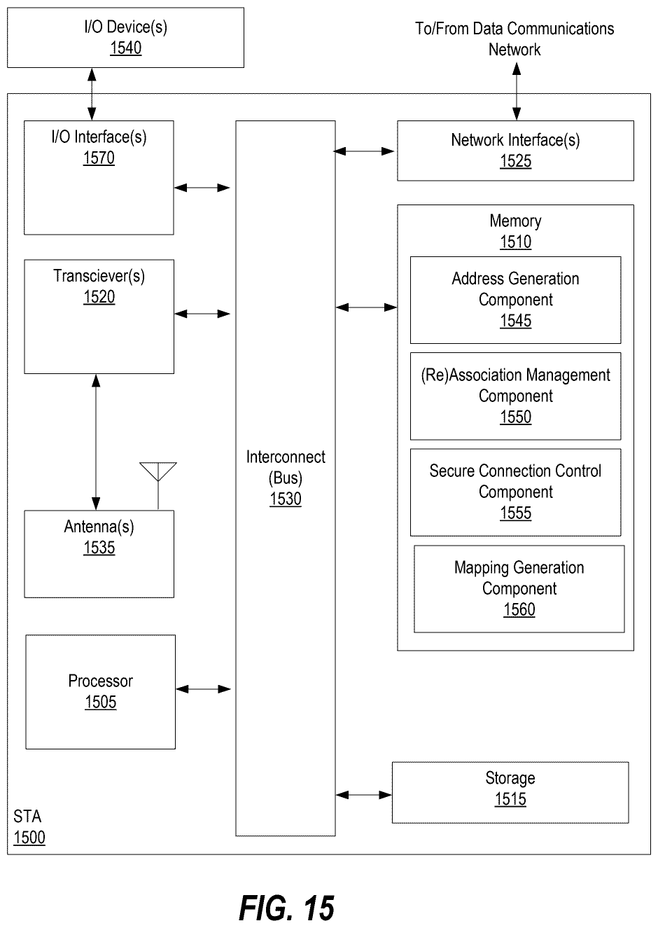

FIG. 15 depicts an example client device 1500 configured to perform various aspects of the present disclosure, according to some aspects of the present disclosure.

In some embodiments, the example client device 1500 may correspond to STA 105-1 as depicted in FIGS. 1, 2A-2B, 3A-3B, and 4-5. Examples of client devices include smartphones, laptops, IoT devices, or any other wireless computing device that supports seamless roaming within an SMD.

As illustrated, the example network device 1500 includes a processor 1505, memory 1510, storage 1515, one or more transceivers 1520, one or more I/O interfaces 1580, and one or more network interfaces 1525. In some embodiments, I/O devices 1540 are connected via the I/O interface(s) 1580. Further, via the network interface 1525, the network device 1500 can be communicatively coupled with one or more other devices and components (e.g., via a network, which may include the Internet, local network(s), and the like). Each of the components is communicatively coupled by one or more buses 1530. In some embodiments, one or more antennas 1535 may be coupled to the transceivers 1520 for transmitting and receiving wireless signals.

The processor 1505 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1505 processes information received through the transceiver 1520, I/O interfaces 1580, and the network interfaces 1525. The processor 1505 retrieves and executes programming instructions stored in memory 1510, as well as stores and retrieves application data residing in storage 1515.

The storage 1515 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1515 may store a variety of data for the efficient functioning of the system.

The memory 1510 may include random access memory (RAM) and read-only memory (ROM). The memory 1510 may store processor-executable software code containing instructions that, when executed by the processor 1505, enable the network device 1500 to perform various functions described herein for wireless communication. In the illustrated example, the memory 1510 includes four software components: the address generation component 1545, the (re)association management component 1550, the secure connection control component 1555, and the mapping generation component 1560.

In one embodiment, the address generation component 1545 is configured to generate and manage RMAs. When an address conflict is detected, the component 1545 updates the address and resends it to the corresponding AP for reverification.

In one embodiment, the (re)association management component 1550 is designed to manage the initial association and roaming processes, including monitoring network conditions to determine when roaming is desired. During the initial association, the component 1550 generates and sends an association request to an AP. The request includes the RMA (and optionally a DS MAC). If the AP approves the association, the component 1550 proceeds to secure connection setup. The component 1550 further monitors network conditions (e.g., RSSI, latency, packet loss) to determine when roaming is needed. When roaming is initiated, the component 1550 generates and transmits a roaming request to a target AP. The roaming request is PMF-protected using the established PTK and includes the RMAs of the STA to maintain secure and seamless authentication at the target AP.

In one embodiment, the secure connection control component 1555 performs the 4-way handshake with an AP to establish a PTK for encrypted communication. In embodiments where a conflict is detected, the secure connection control component 1555 may cooperate with the address generation component 1545 to generate new RMAs. Once non-conflicting addresses are confirmed, the component 1555 may update the mapping(s) to properly associate the established PTK to the final roaming-specific MAC address of the STA.

In one embodiment, the mapping generation component 1560 generates and maintains a per-AP PTK mapping for managing PTK association with different APs. The component 1560 stores the PTK and its corresponding AP MAC address in a local cache table. When roaming, the component 1560 checks the cache to retrieve the correct PTK for the target AP before encrypting the roaming request.

Although depicted as a discrete component for conceptual clarity, in some embodiments, the operations of the depicted components (and others not illustrated) may be combined or distributed across any number of components. Further, although depicted as software residing in memory 1510, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including elements A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a first access point (AP) in a seamless mobility domain (SMD), a message as part of an initial association process with a station (STA);
establishing, by the first AP, one or more roaming-specific media access control (MAC) addresses (RMAs) for the STA as part of message exchange during the initial association process;
establishing, by the first AP, a first pairwise transient key (PTK) with the STA; and
generating, by the first AP, a PTK mapping that associates the first PTK with the one or more RMAs of the STA.

2. The method of claim 1, wherein the one or more RMAs are provided by the STA to the first AP in one of:
an association request,
a reassociation request,
Message 2 of a 4-way handshake, or
Message 4 of the 4-way handshake.

3. The method of claim 1, wherein the one or more RMAs are assigned by the first AP and provided to the STA in one of:
an association response,
a reassociation response,
Message 1 of a 4-way handshake, or
Message 3 of the 4-way handshake.

4. The method of claim 1, further comprising communicating, by the first AP, with the STA using a regular MAC address of the STA for data transmission, wherein the regular MAC address is different from the one or more RMAs.

5. The method of claim 2, further comprising:
determining, by the first AP, whether the one or more RMAs provided by the STA conflict with existing MAC addresses within the SMD;
in response to determining a conflict, providing, by the first AP, an RMA collision warning to the STA; and
receiving, by the first AP, one or more new RMAs from the STA for use in subsequent roaming events.

6. The method of claim 2, further comprising:
determining, by the first AP, whether the one or more RMAs provided by the STA conflict with existing MAC addresses within the SMD;
in response to determining a conflict, providing, by the first AP, an RMA collision warning to the STA; and
assigning, by the first AP, one or more new RMAs to the STA for use in subsequent roaming events.

7. The method of claim 1, further comprising:
sharing, by the first AP, the PTK mapping with one or more second APs in the SMD, wherein the PTK mapping comprises the one or more RMAs and the first PTK, and the one or more second APs use the PTK to communicate with the STA.

8. The method of claim 1, wherein the first PTK is used specifically for communication between the first AP and the STA, and the method further comprises:
sharing, by the first AP, the one or more RMAs with one or more second APs in the SMD, wherein each of the one or more second APs establishes a respective second PTK with the STA, and maps the shared RMAs to the respective second PTK.

9. The method of claim 8, wherein the second AP, after receiving the PTK mapping from the first AP, is configured to:
receive a roaming request from the STA as part of a roaming process, the roaming request comprising one of the one or more RMAs and being encrypted using the first PTK;
retrieve the first PTK by checking the received PTK mapping based on a RMA, among the one or more RMAs, within the roaming request;
decrypt the roaming request using the first PTK; and
send a roaming response to the STA to complete the roaming process.

10. The method of claim 9, wherein the roaming request comprises the RMA as a transmitter address (TA) in a media access control (MAC) header of the roaming request.

11. The method of claim 9, wherein the roaming request further comprises one or more next RMAs for use by the STA in subsequent roaming transitions, and the second AP is further configured to:
determine whether the one or more next RMAs conflict with existing MAC addresses within the SMD; and
in response to determining that there is no conflict, update the PTK mapping to associate the one or more next RMAs with the first PTK of the STA.

12. The method of claim 9, wherein the second AP is further configured to:
assign one or more next RMAs to the STA in a roaming response; and
update the PTK mapping to associate the one or more next RMAs with the first PTK.

13. The method of claim 12, further comprising:
embedding the one or more next RMAs within an encrypted part of the roaming request, or
embedding the one or more next RMAs within an encrypted part of the roaming response.

14. The method of claim 1, wherein the message further comprises a distribution system (DS) MAC address for the STA, the method further comprises:
generating, by the first AP, a PTK mapping that associates the first PTK with the DS MAC address of the STA; and
generating, by the first AP, an address mapping that associates the DS MAC address with the one or more RMAs.

15. The method of claim 14, further comprising:
sharing, by the first AP, the PTK and address mappings with at least one of one or more second APs in the SMD or a wireless controller in the SMD.

16. The method of claim 11, wherein the one or more next RMAs are encoded within the roaming request as one of:
a transmitter address (TA) field in a media access control (MAC) header of the roaming request,
a new element added to the roaming request, or
a subfield within an existing element of the roaming request.

17. A system of a first access point (AP), comprising:
one or more computer processors; and
one or more memories collectively containing one or more programs, which, when executed by the one or more computer processors, perform an operation, the operation comprising:
receiving, by the first AP in a seamless mobility domain (SMD), a message as part of an initial association process with a station (STA);
establishing, by the first AP, one or more roaming-specific media access control (MAC) addresses (RMAs) for the STA as part of message exchange during the initial association process;
establishing, by the first AP, a first pairwise transient key (PTK) with the STA; and
generating, by the first AP, a PTK mapping that associates the first PTK with the one or more RMAs of the STA.

18. The system of claim 17, wherein the one or more RMAs are provided by the STA to the first AP in one of:
an association request,
a reassociation request,
Message 2 of a 4-way handshake, or
Message 4 of the 4-way handshake.

19. The system of claim 18, wherein the operation further comprises:
determining, by the first AP, whether the one or more RMAs provided by the STA conflict with existing MAC addresses within the SMD;
in response to determining a conflict, providing, by the first AP, an RMA collision warning to the STA; and
receiving, by the first AP, one or more new RMAs from the STA for use in subsequent roaming events.

20. The system of claim 17, wherein the one or more RMAs are assigned by the first AP and provided to the STA in one of:
an association response,
a reassociation response,
Message 1 of a 4-way handshake, or
Message 3 of the 4-way handshake.

21. The system of claim 17, wherein the operation further comprises:
sharing, by the first AP, the PTK mapping with one or more second APs in the SMD, wherein the PTK mapping comprises the one or more RMAs and the first PTK, and the one or more second APs use the PTK to communicate with the STA.

22. A method, comprising:
sending, by a station (STA) in a seamless mobility domain (SMD), a message as part of an initial association process to a first access point (AP);
establishing, by the STA, one or more roaming-specific random media access control (MAC) addresses (RMAs) with the first AP as part of message exchange during the initial association process;
establishing, by the STA, a first pairwise transient key (PTK) with the first AP, wherein the first PTK is used specifically for protecting communication between the first AP and the STA and cannot be used for protecting communications with any other second APs in the SMD; and
generating, by the STA, a per-AP PTK mapping, wherein the per-AP PTK mapping associates:
the first AP with the first PTK, and
one or more second APs in the SMD with respective PTKs, each established through a separate process during roaming and used for communication between the STA and respective second APs, wherein one or more RMAs are used in a roaming request transmitted to a second AP.
